(19) United States
(12) Patent Application Publication
(10) Pub. No.: US 2013/0223187 A1
(43) Pub. Date: Aug. 29, 2013

(54) Geological Structure Contour Modeling and Imaging

(71) Applicants: Mangat Rai Thapar, Tulsa, OK (US); Jay Kumar Thapar, Katy, TX (US)

(72) Inventors: Mangat Rai Thapar, Tulsa, OK (US); Jay Kumar Thapar, Katy, TX (US)

(73) Assignee: INTERNATIONAL GEOPHYSICAL COMPANY, INC., Tulsa, OK (US)

(21) Appl. No.: 13/294,736

(22) Filed: Nov. 11, 2011

(51) Int. Cl. G01V 1/00

(52) U.S. Cl. 367/73

(57) ABSTRACT

The invention is a method for geological structure contour modeling and imaging beneficial for quality control and evaluating aerial extent parameter during seismic survey design, quality control of process of migration during processing stage of seismic data, and quality control of structure maps during interpretation of 3-D seismic volume. This method provides a quick and efficient parametric 3-D representation of geologic structures, also allows the use of existing depth data for structure contour modeling and imaging. Normal incident rays, either linear or curved, are traced starting from points along selected contours of structural surface and ending at imaged points on the recording surface to define projected location of the imaged structure contours at the recording surface. Further analysis and quality control is conducted by generating structure maps utilizing third party software using structure contour data, and data for the corresponding contours imaged on the recording surface.

### BACKGROUND OF THE INVENTION

1 Field of the Invention

This invention relates generally to geophysical exploration. This method relates specifically to seismic reflection survey design, seismic modeling, migration of seismic data, contouring, and structural mapping in seismic interpretation. This invention is a method of geological structure contour modeling and imaging. In another embodiment, this method is an efficient and effective tool for quality control during seismic survey design, acquisition, processing, mapping, and interpretation.

Definitions and descriptions of basic terminology and related subject matter can be found in the following references: Nettleton (1940), Dobrin (1970), Sheriff et al (1995), Telford et al (1978), and Sheriff (1991). The coordinates (x, y, z) represent the x, y, and z axes. The dimensions necessary for a geologic structure are, the areal coordinates x and y, and depth coordinate z. The depth coordinate is measured from the surface of the earth. The use of the term “structure” refers to a geologic structure in this document. The structure contours define the shape of a geologic structure in 3-D. The structure length, width, height, and depth are required for seismic survey design, data acquisition, migration of seismic data, and reliability of structure maps generated in interpretation.

Before conducting a 3-D seismic survey, geoscientists calculate the areal extent of the structure length, width, height, and depth. During survey design, a source-receiver layout template is designed based on the subsurface geologic information. The designed template specifies the surface location of each source and receiver used for collection of seismic data. Areal extent is the first parameter calculated at the start of the survey design. A correct value of the areal extent parameter is necessary to collect all of the required reflection data for imaging the subsurface structure. Areal extent parameter defines the maximum x and y dimensions of the exploration area of interest for conducting a 3-D seismic survey. The quality of the imaged structure and cost of the survey are directly proportional to the size of the areal extent. The larger areal extent requires a larger area to be surveyed, and resulting in higher costs. A smaller areal extent will reduce costs and will result in insufficient data collection. A deficient data acquisition is detrimental to the quality of the seismic data and imaged structure. The maximum x, y, dimensions of the survey are determined by the areal extent of the geologic structure. The extent of the structure in the subsurface is defined by the length and width of the structure.

The areal extent parameter depends on factors of structural length, width, height, dip, and depth. The combination of length, width, and height establish the dip of the structure. Steeper dips require larger areal extent and gentler dips need smaller areal extent. An increase in the structure depth increases the areal extent. A decrease in the structure depth decreases the areal extent. The areal extent must be larger than the extent of the structure in the subsurface. A smaller than necessary areal extent will result in acquiring deficient data due to missing reflections from steeply dipping parts of the geologic structure. Missing data will cause critical gaps in the recorded data. These gaps will adversely affect the process of migration to position seismic reflections from steep dips to their correct subsurface location. The migration process will produce a partially imaged structure with important sections missing. Missing reflections from steep dips are the cause of deficient migration. Therefore, migration produces a discontinuous structural image with important gaps. Discontinuous or missing reflections from a steep structure make interpretation difficult and ambiguous, and consequently it increases the exploration risk.

Another area of geophysical prior art which relates to this invention is seismic modeling. Major oil and gas exploration companies use 1-D, 2-D, and 3-D seismic modeling techniques described as follows:
(a) 1-D seismic modeling requires depth dimension z. A synthetic seismic trace is generated by convolving a seismic wavelet with reflection coefficients. A seismic wavelet is usually extracted from seismic data. Reflection coefficients are calculated from velocities, and densities obtained from a sonic log. This synthetic trace can also be obtained from VSP (Vertical Seismic Profile) data. This technique does not offer geological structure contour modeling and imaging as described in this invention.
(b) 2-D seismic modeling requires coordinates of x and z for defining each layer boundary in the geological model. The required input data include primary and shear wave velocities along with density for each layer. This modeling technique generates synthetic zero offset vertical sections. This technique can be utilized to generate unmigrated and migrated vertical sections in two dimensions. This modeling in 2-D is used to simulate acquisition of raw seismic data in a 2-D survey in the field. This 2-D modeling method also does not offer the geological structure contour modeling and imaging as described in this invention.
(c) 3-D seismic modeling requires 3-D coordinates of x, y, z for defining each horizon surface in the model.

The required input data include primary and shear wave velocities along with density for each layer. 3-D modeling is used to generate synthetic zero offset volume, also known as migrated and un-migrated seismic volume. 3-D modeling can also be used to simulate acquisition of raw seismic data in a 3-D survey in the field. 3-D modeling method also does not offer geological structure contour modeling and imaging as described in this invention. However, 3-D modeling can be utilized through multiple steps as described later in these specifications for calculating the areal extent of a geological structure.

Seismic ray tracing is a practical technique of simulating seismic data acquisition in the field. Ray tracing algorithms follow Snell's law. Normal incident ray starts at the surface source-receiver location and transmits into the subsurface. The incident ray contacts the geologic boundary at an incident angle of 0° from the normal. This means that this ray is normal to the geologic structure. The incident ray reflects to the starting source-receiver location on the recording surface. For normal incident, the source-receiver locations are considered coincident. This means that source and receiver occupy the same position on the surface. If the medium of ray transmission has a constant velocity, then the rays follow linear paths. However, if there is a velocity gradient present in the subsurface, then the ray paths are curved. The Oblique incident rays are traced for simulating acquisition of seismic data because the source to receiver distance varies significantly. Oblique ray starts at the source location on the surface and transmits into the subsurface. This ray contacts the reflector at a given angle of incident from the normal. Following the impact, the ray reflects at a reflection angle equal and opposite to the incident angle. The reflection arrives at a surface receiver location at an offset distance from the source determined by the angle of reflection.

Seismic modeling is useful for geoscientists to simulate various aspects of seismic exploration from survey design to interpretation. Ray trace modeling helps in understanding seismic wave propagation starting at the surface, transmitting down to the geologic boundaries, and reflecting to the surface. Seismic modeling is useful for generating synthetic seismic sections for solving problems and improving velocity analyses during processing. Synthetic traces from sonic log data are commonly employed during interpretation of seismic data to identify and relate geologic boundaries to seismic reflections. Normal incident 3-D Ray trace modeling can also be used to determine the areal extent parameter for a geologic structure. Each ray trace, starts from a source, and impacts along the normal to the structure, and then reflects to the source. The source receivers are considered to be occupying the same location for normal incident rays. This process is repeated until all specified source-receiver locations have rays traced in this manner. Main drawback of this method is that the areal extent is controlled by the source-receiver layout and areal distribution. Because of the effect of depth and dip, thousands of rays are traced between the surface and the structure. An incident ray starts from a source location at the surface and transmits into the subsurface. On contact with the structure, this incident ray is reflected to a receiver location on the surface. The reflecting points of these rays are haphazardly distributed in x and y coordinates on the structure surface. Therefore, it is very difficult to isolate rays reflected from a subsurface structure contour, and relate them to the surface source-receiver locations. This ray trace modeling does not produce a clear and consistent view to make a reliable estimate of the areal extent. It is because the result is dependent on the design of the template to layout sources and receivers.

There is a definite need for a technique to estimate the areal extent parameter from known structural parameters. Without a clearly defined areal extent, it is common to select a smaller areal extent for economic reasons. Inventors of this method grasped the problem, and developed this method for producing a well defined areal extent for a geologic structure. This method traces normal incident linear/curved rays, starting from points along selected structure contour to the recording surface, resulting in corresponding imaged contour on the recording surface. This process of ray tracing is repeated for all specified structure contours to produce corresponding imaged contours on the recording surface.

For land seismic surveys, the surface of the earth is known as the recording surface. For marine seismic surveys, the recording surface is either surface of the water or the sea bottom. The structure contours will also be called migrated contours, and the imaged contours will be called unmigrated contours. The points along the imaged contours provide source-receiver locations, which will receive normal incident rays reflected from the corresponding point on the structure contour. Tracing rays from all points along structure contours produces a clear view of the imaged contours on the surface. The areal extent parameter is obtained by enclosing all imaged contours within a rectangle, and the dimensions of this rectangle define the areal extent parameter for the geologic structure to be surveyed.

Seismic survey parameters are estimated or selected during survey design. Areal extent is the first and most important parameter used in the collection of seismic data. Areal extent defines the (x, y) boundary of the seismic data collection in the field. The areal extent parameter and imaged contours provide quality control of data acquisition for missing data due to obstacles or other factors. The areal extent parameter also plays an important role in migration of seismic data during the data processing. For flat reflectors, raw seismic reflections are in correct subsurface positions compared to the locations of corresponding sources and receivers. For dipping reflectors, raw seismic reflections are not in correct positions relative to the corresponding sources and receivers. Migration process moves seismic reflections from dipping reflectors to their correct subsurface locations. For flat reflectors, no migration of seismic data is necessary. Full volume of recorded seismic data is not available in the computer memory at a given time during migration. A reduced size of data volume is continually created and used as migration of data progresses in the computer memory. The areal extent parameter provides the required limits for the reduced volume. This ensures that all reflections from steeply dipping structure are in the computer memory at a given time to complete the migration process successfully.

The quality and accuracy of structure maps based on seismic data are controlled by three important areas of seismic exploration: seismic survey design, seismic data processing, and seismic interpretation. The areal extent parameter is calculated in survey design, and implemented in acquisition. Areal extent parameter is used to establish the correct migration aperture in migration of seismic data. Further application of areal extent is to establish the quality and reliability of a 3-D seismic data. Quality of 3-D data establishes the quality of structure maps. Missing reflection data from steep slopes, due to a smaller areal extent, results in partial imaging by migration. This absence of data leaves gaps in the reflection data causing the imaged structural surface to be discontinuous with critical gaps. However, if the areal extent is sufficient for the target structure, all reflections from steep dips will be recorded. The complete recorded data will enable the migration of data to produce a continuous surface including steeply dipping zones. The missing critical data will result in unreliable interpretation because of unreliable structure contour maps. Interpretation carried out in spite of the missing data will produce unreliable contour maps. Drill locations picked on such maps are highly suspect and risky. Such drill locations will result in drilling dry holes costing a few hundred thousand to millions of dollars. Therefore, a good estimate of the areal extent is necessary for the success of the seismic survey and the oil and gas exploration program.

The success of the oil and gas exploration depends, on a proper survey design to meet the requirement of the target structure. Reliability of seismic data is controlled by accurate migration of seismic data and by correct interpretation. Success of the exploration program depends on the selection of a potential location to drill. The success of exploration starts with the selection of appropriate areal extent for the 3-D seismic survey. Insufficient areal extent would result in a wasted 3-D survey and drilling dry holes costing hundreds of thousands to millions of dollars. This method is a valuable tool for effectively modeling the structure, and for estimating the areal extent. This areal extent parameter forms the basis of a reliable 3-D survey design. This method shows the crossing contours and their location on the recording surface. The crossing contours provide quality control for migration and interpreted structure maps.

2. Discussion of the Prior Art

Normal incident linear and curved ray tracing have been used in geophysical exploration since the early 1900s. References to curved ray are Sheriff and Geldart (1995), Telford et al (1976), Dobrin (1976), and Nettleton (1940). In addition, contours, contour maps, dip maps, structure maps and cross-sections are routinely used by geoscientists in oil and gas exploration. Following are some of the patents on subject matter related to this method:

U.S. Pat. No. 4,415,999, “Method of Confirming Seismic Data Interpretation”, issued to George P. Moeckel et al., describes an improved method of generating synthetic seismograms : “An improved method of generating synthetic seismograms for use in determining the accuracy of hypothesized subterranean structures is disclosed. The method features defining hypothesized detector locations corresponding to real detector locations rather than interpolating from arbitrary detector locations generated by specifying of initial ray path angles as input data. The accuracy of the results is improved by elimination of interpolation”.

U.S. Pat. No. 4,679,174, “Method for seismic lithologic modeling”, issued to Valery A. Gelfand, describes a method of lithologic modeling as: “A method of seismic exploration of the subsurface of the earth. Seismic reflection data are gathered in a selected area. The seismic data are combined with available non-seismic data to define an initial two-dimensional lithologic model. Based upon the initial model, a set of synthetic seismic data is generated. The degree of correspondence between the set of synthetic reflection data and the gathered seismic data is determined. The initial model-parameters are systematically perturbed during a series of iterations until a desired degree of correspondence has been achieved, resulting in a final lithologic model.”

U.S. Pat. No. 4,766,574, “Method for Depth Imaging Multicomponent Seismic Data”, issued to Norman D. Whitmore, Jr. et al., describes a method for imaging multicomponent seismic data as: “The present invention relates generally to a method of geophysical exploration and more particularly to a novel method for imaging multicomponent seismic data to obtain better depth images of the earth's subsurface geological structure as well as better estimates of compressional and shear wave interval velocities. In particular, measures are obtained of imparted seismic wavefields incident on reflecting interfaces in the earth's subsurface and of resulting seismic wavefields scattered therefrom. The incident and scattered seismic wavefields are employed to produce time-dependent reflectivity functions representative of the reflecting interfaces. By migrating the time-dependent reflectivity functions, better depth images of the reflecting interfaces can be obtained. For a dyadic set of multicomponent seismic data, the dyadic set of multicomponent seismic data are partitioned so as to separate the variously coupled incident and reflected wavefields in the recorded multicomponent seismic data. The incident and reflected wavefields are cross-correlated to form time-dependent reflectivity functions. The time-dependent reflectivity functions are then iteratively migrated according to a model of wavefield velocities of propagation to obtain better estimates of the compressional and shear wave interval velocity. The migrated reflectivity functions can then be stacked to produce better depth images of the earth's subsurface geological structures.”

U.S. Pat. No. 4,953,142, “Model-based depth processing of seismic data”, issued to Daniel H. Rimmer, describes a method of Model-based depth processing of seismic data as: “A model-based iterative method of depth-processing seismic data. An estimate of a geologic horizon is entered into a three-dimensional seismic model and synthetic shot records are determined from the model. Reflection tracks are estimated from the modeling results. The actual seismic traces are sorted into bins according to common reflection points determined from the reflection tracks and are stacked. The sorted and stacked data are used to estimate the difference between the seismic travel time and the model travel time, and the model is changed in order to match the seismic data. The process is repeated until the margin of error is acceptable. Lower horizons of interest are modeled in the same way until all the horizons of interest in a geological area are determined.”

U.S. Pat. No. 4,972,383, “Method of obtaining a model representative of a heterogeneous medium, and particularly the sub-soil”, issued to Patrick Lailly, describes a method of modeling heterogeneous medium as: “A method for providing an optimum model having at least two dimensions of a heterogeneous medium, representing the variations of at least one physical parameter, for example the acoustic impedance of underground formations, and satisfying as well as possible the data measured in situ, for example well-logging in wells in studying the sub-soil as well as other data relative to the medium studied, for example geological information and seismic surface recordings. The method includes the construction of a reference model and the definition of covariance operators which model the uncertainties not only in the medium studied but also in the recordings obtained from outside the medium, for example seismic sections. Comparison between the effective recordings and others which are formed on the basis of the constructed model, makes it possible to check the validity thereof. The resolution method chosen results in coupling together different information used and separating the coherent parts (the signals) from the incoherent parts (the noise).”

U.S. Pat. No. 5,229,976, “Method for creating a numerical model of the physical properties within the earth”, issued to Mark Boyd, and Douglas W. Hanson, describes a method for creating a numerical model of physical properties of the earth as: “The present invention provides a simple and geologically logical method for creating a numerical model of the physical rock properties (e.g., velocity) within a two-dimensional slice of the earth. The present invention is a model building process, a method of translating a drawn or imagined model into a numerical format. In the method of the present invention the concept of cells is utilized. Cells are defined as the smallest areas enclosed by a series of digitized interfaces. The model will be split into a set of cells, polygons which fit tightly together leaving no gaps. The present invention solves the problem of representing the modeled structure without the need for special rules. Even when an extremely complex structure is to be represented, the geoscientist is required only to enter his interpretation of the subsurface, picked horizons and faults, without manipulation to suit the model building process.”

U.S. Pat. No. 5,838,634, “Method of generating 3-D geologic models incorporating geologic and geophysical constraints”, issued to Thomas A. Jones et al., describes a method of generating 3-D geologic models as: “Features of subsurface earth reservoirs of interest are made available for analysis and evaluation by forming three-dimensional, geologic block models based on field data. The field data include geological observations, such as lithofacies and porosity values obtained from well data and other sources, as well as geophysical data, usually from seismic surveys. The geologic models representative of subsurface reservoirs so obtained are optimized to match as closely as feasible geologic constraints known or derived from observed geologic data. The models also conform to geophysically based constraints indicated by seismic survey data. The modeled geologic lithofacies and porosity are converted into acoustic velocity and bulk density values, which are then formulated as a seismic response which is then compared with actual seismic data. A perturbation process on lithofacies and porosity can be iteratively repeated until a representation of the reservoir is obtained which is within specified limits of accuracy or acceptability.”

U.S. Pat. No. 6,381,543, “Method for forming a model of a geologic formation, constrained by dynamic and static data”, issued to Dominique Guerillot et al., describes a method for forming a model of a geologic formation as: “Method for forming, by means of an inversion technique, a model of an underground zone, constrained by static data: data obtained by seismic exploration or measured in situ (logs), and by dynamic data: production measurement, well testing, etc. From an a priori selected meshed geologic model and from relations between parameters or physical quantities characteristic of the medium: acoustic impedance and cabsolute permeability for example, a simultaneous inversion of the two parameters is performed by minimizing a global cost function, which has the effect of considerably decreasing the number of possible solutions and of improving characterization of the underground zone. The method can be used notably for modelling hydrocarbon reservoirs, of zones likely to be used as gas, waste storage places, etc.”

U.S. Pat. No. 6,549,854, “Uncertainty constrained subsurface modeling”, issued to Alberto Malinvemo et al., describes a method for uncertainty constrained subsurface modeling as: “A method, apparatus, and article of manufacture are provided that use measurement data to create a model of a subsurface area. The method includes creating an initial parameterized model having an initial estimate of model parameter uncertainties; considering measurement data from the subsurface area; updating the model and its associated uncertainty estimate; and repeating the considering and updating steps with additional measurement data. A computer-based apparatus and article of manufacture for implementing the method are also disclosed. The method, apparatus, and article of manufacture are particularly useful in assisting oil companies in making hydrocarbon reservoir data acquisition, drilling and field development decisions.”

U.S. Pat. No. 6,665,618, “Seismic survey design technique”, issued to Thomas et al, describes this method as: “An improved system for designing seismic surveys wherein the density and areal size of the seismic survey components (e.g., sources or receivers) are selected based on a plurality of calculated templates of the components that are generated using a mapping function”.

U.S. Pat. No. 7,689,396, “Targeted geophysical survey”, issued to Steven Blake Campbell, describes this method as: “In one embodiment the invention comprises a system for planning a seismic survey based on a model of a subsurface formation in which a computer simulation is generated having sources and receivers positioned in selected locations with respect to the model. Ray tracing is performed from the sources to estimate a propagation ray path of seismic signals emanating from the source locations, and emergent points are determined at which ray paths reach the earth's surface following reflection from a subsurface area of interest. A survey may then be designed and performed in which receiver positions are concentrated at the areas where the emergent points are concentrated.”

U.S. Pat. No. 7,752,022, “Method for updating a geologic model by seismic and production data”, issued to Alexandre Fornel et al., describes a method for updating a geologic model as: “The invention is a method, having applications for the development of reservoirs, for predicting the production of an underground reservoir, comprising generating and updating a parameterized geologic model from production data and seismic data and in particular 4D seismic data which may be used in development of oil reservoirs. According to the method, production data are simulated from the geologic model and a flow simulator, and a petro-elastic depth model is deduced there from. A depth/time conversion model is then defined, by means of which the petro-elastic model is converted into time. The model is adjusted by correcting the lag induced by the depth/time conversion and by recalibrating the model. The geologic model is optimized by comparing, through an objective function, the real measurements with the simulation responses (production responses and seismic attributes in time) by updating in particular the depth/time conversion model.”

The above referenced patents focus on seismic modeling methods, forming and updating geologic models, synthetic seismograms, depth imaging with multi-component seismic data, model based depth processing of seismic data, and design 3-D survey parameters. The above methods do not discusses or present the imaging or modeling structure contours as presented in this invention.

### REFERENCES CITED [REFERENCED BY]U.S. PATENT DOCUMENTS

| | | |
|---|---|---|
| 4,415,999 | November 1981 | Moeckel |
| 4,679,174 | July 1987 | Gelfand |
| 4,766,574 | August 1988 | Whitmore |
| 4,953,142 | August 1990 | Rimmer |
| 4,972,383 | November 1990 | Lailly |
| 5,229,976 | July 1993 | Boyd, et al. |
| 5,838,634 | November 1998 | Jones et al. |
| 6,381,543 | April 2002 | Guerillot et al. |
| 6,549,854 | April 2003 | Malinverno et al. |
| 6,665,618 | December 2003 | Thomas et al |
| 7,689,396 | March 2010 | Campbell |
| 7,752,022 | July 2010 | Fornel, et al. |

### OTHER REFERENCES

Bamberger, A., “Inversion of normal incidence seismograms”, Geophysics, vol. 47, pp. 757-770, May 1982.

Bortoli, L., “Selection of Stochastic Reservoir Models Using Iterative Forward Matching of Seismic Traces”, pp. 1-27, May 1992.

Bulant, Petr., “Two-Point Ray Tracing in 3-D heterogeneous Block Structures.” Department of Geophysics, Charles University.

Denver, L. E., “The Impact of Vertical Averaging on Hydrocarbons Volumetric Calculations—A Case Study, Computer Modeling of Geologic Surfaces and Volumes”, (D. E. Hamilton and T. A. Jones, editors): Amer. Assoc. Petroleum Geology, Tulsa, pp. 219-234, 1992.

Deutsch, C. V., “The Application of Simulated Annealing to Stochastic Reservoir Modeling”, SPE Advanced Technology Series, vol. 2, No. 2, pp. 222-227, April 1994.

Dobrin, M. B., “Introduction to Geophysical Prospecting”, 1976, pp 307-310, McGraw-Hill Book Company, Inc., New York

Nettleton, L. L., “Geophysical Prospecting for Oil”, 1940, pp 256-263, McGraw-Hill Book Company, Inc., New York

Jones, T. A., “Extensions to three dimensions: Introduction to the section on 3-D geologic block modeling, Computer Modeling of Geologic Surfaces and Volumes”, (D. E. Hamilton and T. A. Jones, editors): Amer. Assoc. Petroleum Geology, Tulsa, pp. 175-182, 1992.

Jones, T. A., “Contouring Geologic Surfaces With the Computer, Chapter 4, Simple Grids and Contour Maps”, pp. 43-59, 1986.

Journel, A. G., “Integrating Seismic Data in Reservoir Modeling: The collacated Cokriging Alternative”, Stanford Center for Reservoir Forecasting, School of Earth Sciences, pp. 1-34, 1992.

Sheriff, R. E., “Encyclopedic Dictionary of Exploration Geophysics”, pp 1-376, Society of Exploration Geophysics, Tulsa Okla., U.S.A, 1991.

Sheriff, R. E., and Geldart, L. P., “Exploration Seismology”, pp 91-95, 2^{nd} Edition, Cambridge University Press, Cambridge, U.K., 1995.

Telford, W. M., Geldart, L. P., Sheriff, R. E., and Keys, D. A., “Applied Geophysics”, pp 272-275, Cambridge University Press, Cambridge, U.K., 1978.

### SUMMARY OF THE INVENTION

This method is implemented as an automated computer technique on a general purpose computer. Structure parameters of depth, width, length, and height are used as input parameters for the computer algorithm. A parametric representation of the 3-D structure is created using a Gaussian, or other smoothly varying function. The structure input parameters of depth, length and width, and height are entered by the user. A 3-D structure is created with user input parameters. This 3-D structure can also be generated by importing structure depth data. The structure is displayed in 3-D using the wire mesh display. The user provides the number of contours, contour interval, and the highest (shallowest) contour. Ray tracing and plotting are carried out starting with the highest (shallowest) contour value and incrementing the successive contour by the contour interval. Either linear or curved normal incident rays are traced starting at reflection points on a given contour to the recording surface. These rays are spaced at a constant interval along the contour. The endpoints of traced rays are terminated at the recording surface, and these endpoints of the normal incident rays form an imaged contour on the recording surface. This process is repeated until linear/curved rays are traced from every point and between points at a fine interval along each specified contour. A small spacing between successive rays provides a better resolution as compared to a large spacing. Areal extent is determined by enclosing all contours imaged on the recording surface by a rectangle. A combined 3-D display of the structure, contours, traced rays, and projected contours on the recording surface is generated. This display shows if the rays from different contours are crossing. If the imaged contours are crossing, then they can be spotted easily on this display.

The algorithm shown in the flowchart in figure number (FIG. 1) is the basis of this computer program. This computer program generates x, y, z coordinates for structure depth, imaged contour data, and gradient data for the structure. These generated x, y, z coordinates are output to a computer storage device. The stored x, y, z coordinates are imported from a computer storage device into a commercially available mapping software program for gridding and mapping. Mapping software grids the data, generates and displays a map on a computer screen. These maps include structure maps, imaged contour maps, and dip maps.

A grid is a rectangular area covering the data area in x and y directions. A rectangular or square grid is divided into an array of lines called rows and columns. The smallest rectangle between two consecutive columns and rows, is known as a cell. Corners or centers of these cells are called nodes. The grid occupies the same x, y dimensions as the data to be gridded, and uses the same coordinate system as that data. Most programs orient the columns and rows parallel to the N-S and E-W directions. The spacing is constant between rows and between columns. The input data, are usually scattered over x, y coordinates. These scattered data are interpolated using one of many available algorithms to calculate a z value for every cell node of a grid. Mapping algorithm draws lines of constant z-values called contours. Each contour can be filled with an appropriate color selected from a color scale. There are commercially available gridding and mapping software programs which can be used for gridding the input data and generating contour maps. These maps are useful for quality controlling the contours of the 3-D structure and model.

A flowchart shows the algorithm of this method in figure number (FIG. 1). This chart shows the steps in this method used in developing a computer program. Third party mapping software in FIG. 1, bottom right, refers to commercially available gridding and mapping software programs. Surfer 10 is the mapping software used to generate the maps presented in the drawing. These programs, grid x, y, z coordinates data, generate and display map of the gridded data on a computer screen. A map is a representation of three variables, x, y, z on a flat surface. For example, z can be the variation of the depth of a geologic structure. In addition, z can be any other value that changes with x, y coordinates, e.g., dip of the structure. Gridding of scattered x, y, z data is carried out by defining a grid with small increment in the x and y directions. The grid extends to the x and y dimensions of the input data. Gridding algorithm calculates the z value for every cell in the grid. Mapping function of the software programs use gridded data to calculate and draw contours at a fixed increment of z-value specified by the user. Each contour represents a constant z value on the map.

### BRIEF DESCRIPTION OF THE FIGURES

The patent or application file contains at least one drawing executed in color. Copies of this patent or patent application publication with color drawing(s) will be provided by the Office upon request and payment of the necessary fee.

The following list provides a brief description of each figure in this specification:

FIG. 1. This is a flowchart showing the flow of the algorithm used in this method of geological structure contour modeling and imaging.

FIG. 2. This figure shows the wire mesh representation of a 3-D structure.

FIG. 3. This figure shows the 3-D structure and selected depth contour. A linear normal incident ray is shown by the line BA.

FIG. 4. This figure shows normal incident rays, traced at a fine interval, starting from a reflecting point on a structure contour and ending at the surface. These rays are for the deepest and the first contour at 4500 m depth.

FIG. 5. This figure shows normal incident, linear rays, traced from contour at 4300 m depth to the recording surface.

FIG. 6. This figure shows normal incident, linear rays, traced from contour at 4100 m depth to the recording surface.

FIG. 7. This figure shows normal incident, linear rays, traced from contour at 3900 m depth to the recording surface.

FIG. 8. This figure shows normal incident, linear rays, traced from contour at 3700 m depth to the recording surface.

FIG. 9. This figure shows normal incident, linear rays, traced from contour at 3500 m depth to the recording surface.

FIG. 10. This figure shows normal incident, linear rays, traced from contour at 3300 m depth to the recording surface.

FIG. 11. This figure shows normal incident, linear rays, traced from contour at 3100 m depth to the recording surface.

FIG. 12. This figure shows normal incident, linear rays, traced from contour at 2900 m depth to the recording surface.

FIG. 13. This figure shows normal incident, linear rays, traced from contour at 2700 m depth to the recording surface.

FIG. 14. This figure shows normal incident, linear rays, traced from contour at 2500 m depth to the recording surface.

FIG. 15. This figure shows normal incident, linear rays, traced from all contours ranging in depth from 2500 m to 4500 m depth. The inside rectangle represents the areal extent obtained with the linear normal incident rays. The outside rectangle represents the areal extent obtained with linear oblique incident rays to account for the maximum source-receiver offset distance.

FIG. 16. This figure shows a depth contour plotted on a 3-D structure. A normal incident linear ray is shown by the line BA. A normal incident curved ray is shown by the curved line BC. The normal incident, linear and curved rays, from a structure contour to the surface lie in a vertical plane.

FIG. 17. This figure shows normal incident, linear and curved rays, from structure contour to the surface in a vertical plane.

FIG. 18. This figure shows normal incident linear and curved rays, from a structure contour to the surface in a vertical plane slicing through the 3-D structure.

FIG. 19. This figure shows the wire mesh representation of a 3-D structure as shown in FIG. 2.

FIG. 20. This figure shows normal incident curved rays, starting from reflection points on a structure contour of 4500 m, and ending at the surface.

FIG. 21. This figure shows normal incident curved rays traced from a contour at 4300 m depth to the recording surface.

FIG. 22. This figure shows normal incident curved rays traced from a contour at 4100 m depth to the recording surface.

FIG. 23. This figure shows normal incident curved rays traced from a contour at 3900 m depth to the recording surface.

FIG. 24. This figure shows normal incident curved rays traced from a contour at 3700 m depth to the recording surface.

FIG. 25. This figure shows normal incident curved rays traced from a contour at 3500 m depth to the recording surface.

FIG. 26. This figure shows normal incident curved rays traced from a contour at 3300 m depth to the recording surface.

FIG. 27. This figure shows normal incident curved rays traced from a contour at 3100 m depth to the recording surface.

FIG. 28. This figure shows normal incident curved rays traced from a contour at 2900 m depth to the recording surface.

FIG. 29. This figure shows normal incident curved rays traced from a contour at 2700 m depth to the recording surface.

FIG. 30. This figure shows normal incident curved rays traced from a contour at 2500 m depth to the recording surface.

FIG. 31. This figure shows normal incident curved rays traced from all contours ranging in depth from 2500 m to 4500 m. The inside rectangle is the areal extent obtained from imaged contours on the recording surface using normal incident curved rays. The outside rectangle is obtained by expanding the inside rectangle by one maximum offset distance in x and y directions.

FIG. 32. This figure shows a structure map generated using recorded contour data displayed on the recording surface in FIG. 31.

FIG. 33. This figure shows a structure map generated using structure contour data.

FIG. 34. This figure shows a structure map generated with structure data. Cross-sections along radial aziumuthal profiles from 0° to 180° at 1° increment are used to generate structure data.

FIG. 35. This figure shows a dip map created using 3-D dip. The 3-D dip is calculated from cross-sections. The cross-sections are derived along radial profiles from 0° to 180° at 1° increment.

FIG. 36. This figure shows a dip map created using dip along profile direction. The dip is calculated from cross-sections. The cross-sections are derived along radial profiles from 0° to 180° at 1° increment.

FIG. 37. This figure shows an absolute dip map created using 3-D dip. The 3-D dip is calculated from cross-sections. The cross-sections are derived along radial profiles from 0° to 180° at 1° increment.

FIG. 38. This figure shows an absolute dip map created using dip along profile direction. The dip is calculated from cross-sections. The cross-sections are derived along radial profiles from 0° to 180° at 1° increment.

### DETAILED DESCRIPTION OF PREFERRED EMBODIMENT

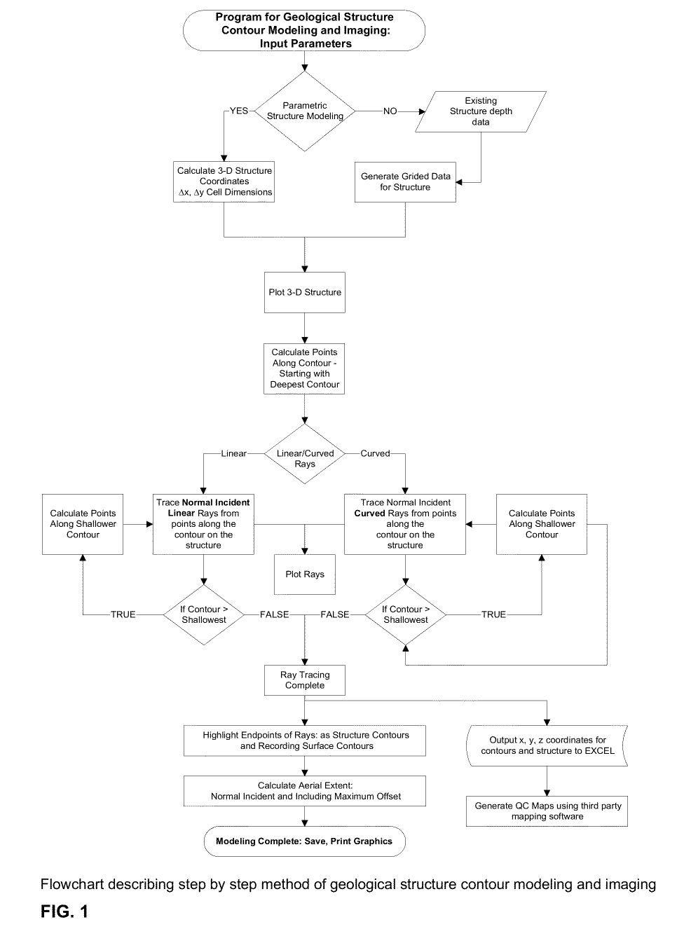

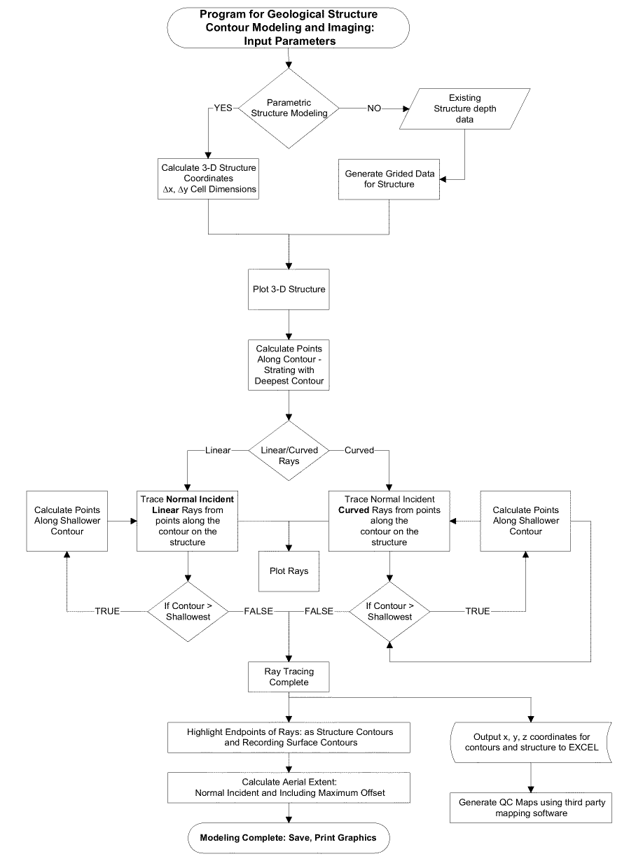

This invention began as an algorithm and developed into a computer program. The computer program includes the steps shown in the flowchart in figure number (FIG. 1). This program is implemented on a general purpose computer. This technique is developed based on a need for a quick and well defined estimate of the areal extent of a 3-D seismic survey necessary for imaging a geologic structure. The objective of finding the areal extent is achieved by 3-D ray trace modeling of a geologic structure contours.

A 3-D structure is defined, based on length, width, shallowest and deepest depths. The coordinates x, y, z of 3-D structure are calculated, and output to a computer storage device. Existing structure depth data can also be imported into this program. Specific number of contours around the structure is selected for ray tracing, and ray tracing interval along a contour is specified. Normal incident linear or curved rays are traced from each specified structure contour to the imaged contours on the recording surface. The endpoints of the rays on the recording surface outline the imaged contour, and starting points of the rays define the structure contour. For one set of rays, the imaged contours on the surface correspond to the structure contour. The areal extent of imaged contours on the recording surface is a measure of the areal extent parameter. The areal extent is necessary and useful for designing a 3-D seismic survey. In this method, ray tracing determines 3-D coordinates of the ray in (x, y, z). Ray coordinates (x, y, z) are scaled to screen coordinates and displayed on the computer screen. Areal extent of the imaged contours on the recording surface is useful in the processing of seismic data to determine the migration aperture. It is also valuable in the interpretation to quality control structure contour maps.

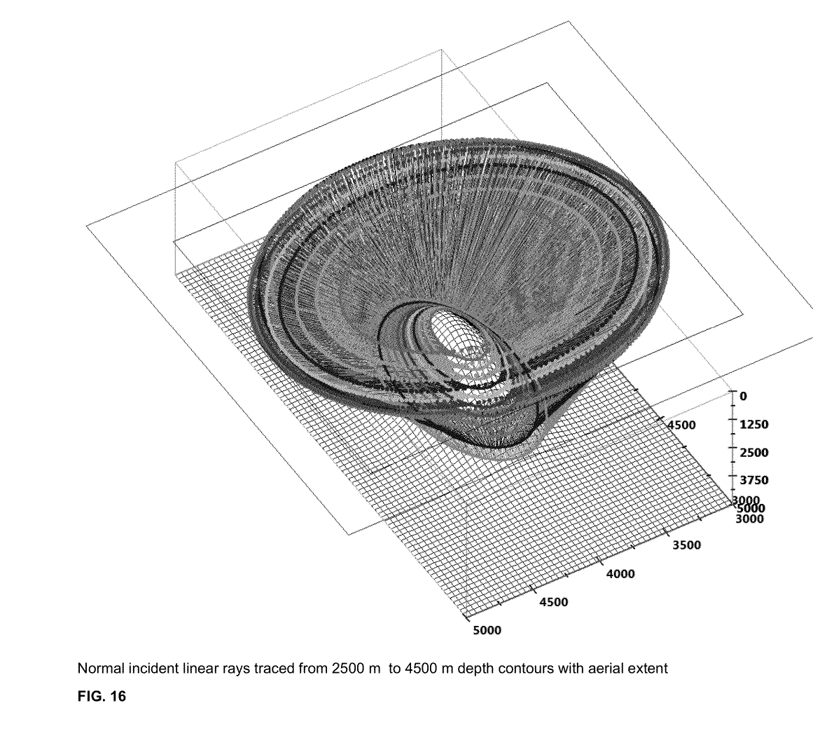

This is a computer based method which defines a 3-D structure from width, length, shallowest and deepest depths. This structure may also be obtained from borehole depths to the structural surface. In FIG. 16, a specific contour is selected, and starting at a point B on this contour, linear/curved rays, BA/BC are traced from B to the recording surface. Linear rays represent constant velocity in the subsurface. Curved rays represent an increase in velocity with depth due to the presence of a velocity gradient in the subsurface.

Point A marks the recording, or imaging, location of reflecting point B on the structure contour for the linear ray tracing and plotting as shown in figure number (FIG. 16). Point C marks the recording, or imaging, location of point B on the structure contour for the curved ray tracing. Point B is the subsurface location which corresponds to point E on the recording surface. Locations A and C are imaged locations of point B on the recording surface for linear and curved ray tracing respectively. For the linear ray, point B is recorded in the subsurface directly below point A at a depth equal to AB. Similarly for the curved ray, point B is recorded below point C at a depth equal to path BC. Location E is the surface location for point B on the structure contour.

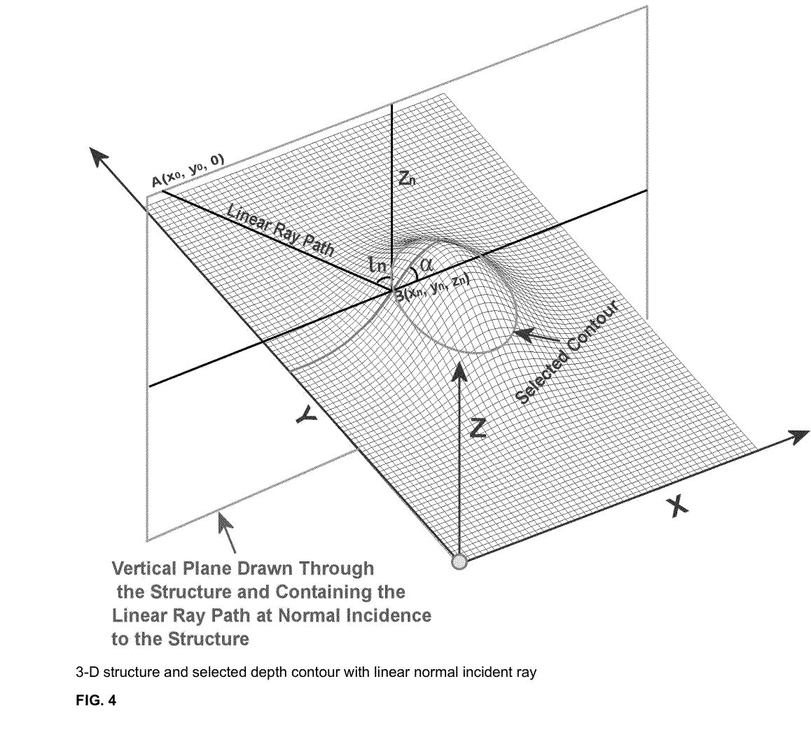

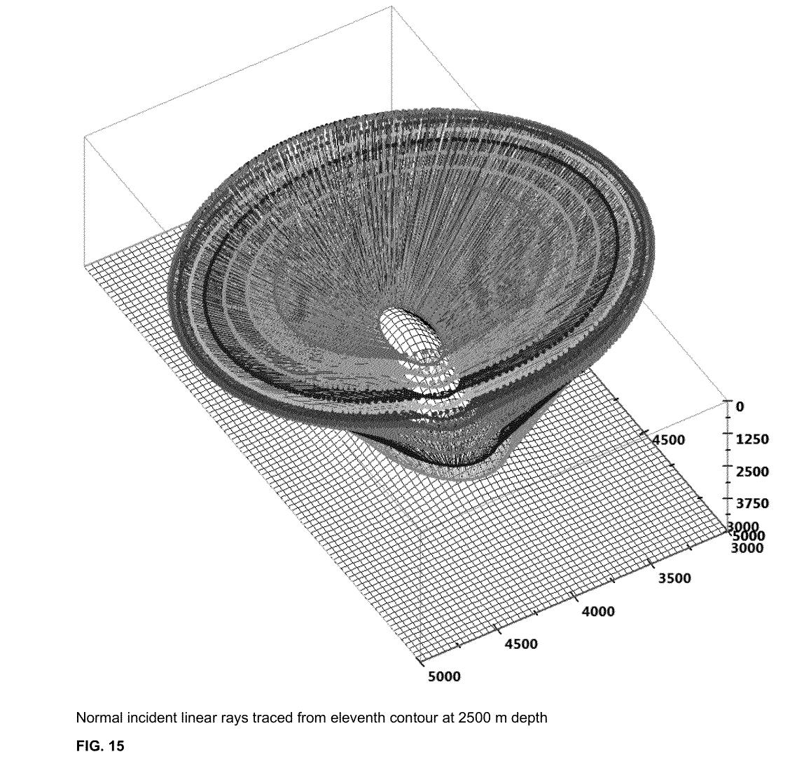

Normal incident linear ray is traced from each point on the structure contour to the recording surface. This ray tracing produces imaged contour points on the recording surface as shown in figure number (FIG. 4). The endpoints of the rays outline a contour on the recording surface, and it is called the imaged contour as shown in figure number (FIG. 4). This imaged contour corresponds to the highlighted contour on the structure display in figure number (FIG. 4). Similar rays are traced from each structure contour to the corresponding imaged contours as shown in figure number (FIG. 15). The coordinates x, y, z of imaged contours are calculated, and output to a computer storage device. The imaged contours are also called unmigrated contours of corresponding structure contours. The structure contours are called migrated contours.

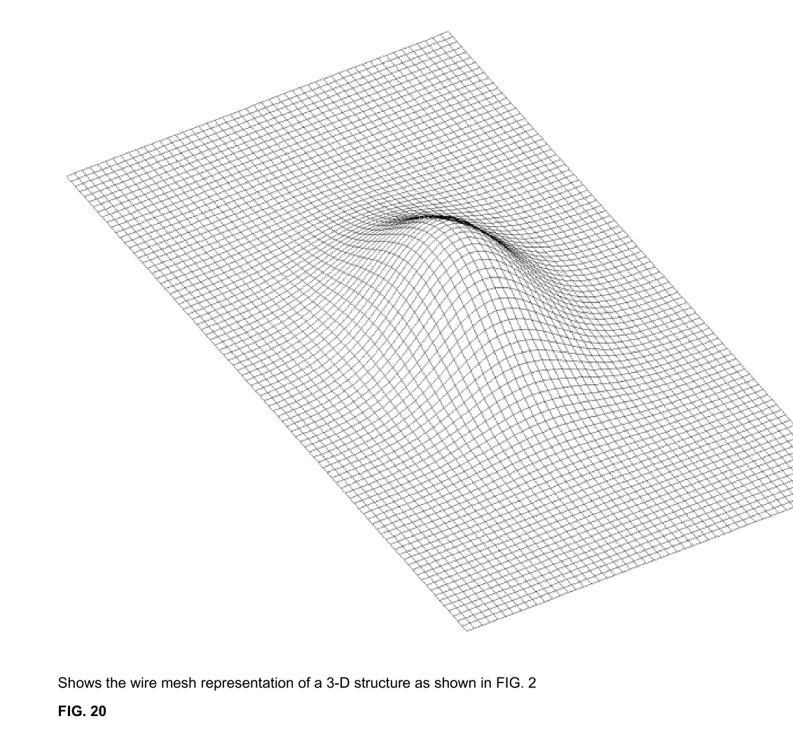

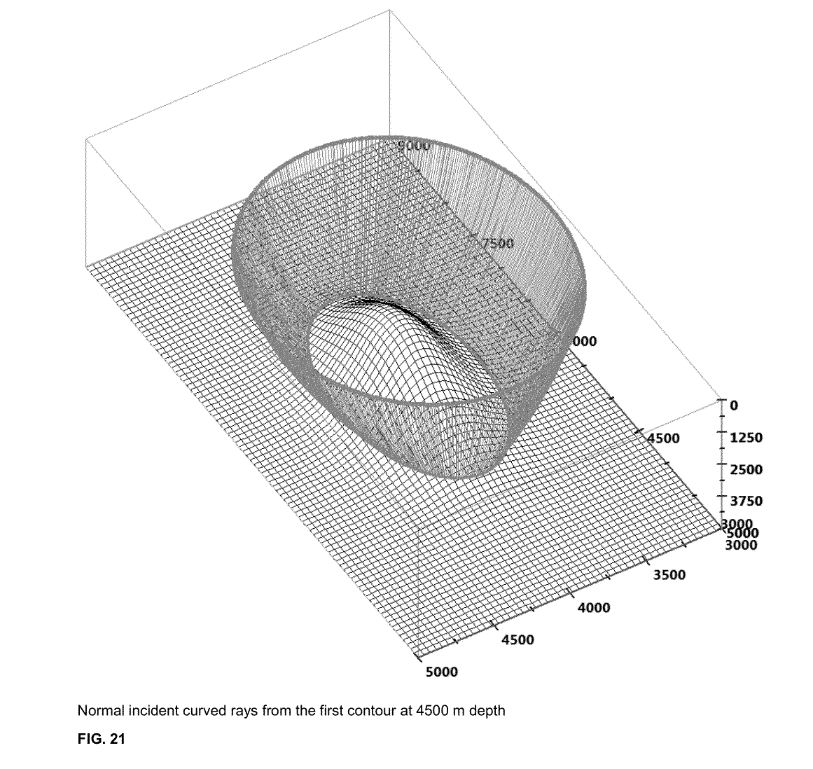

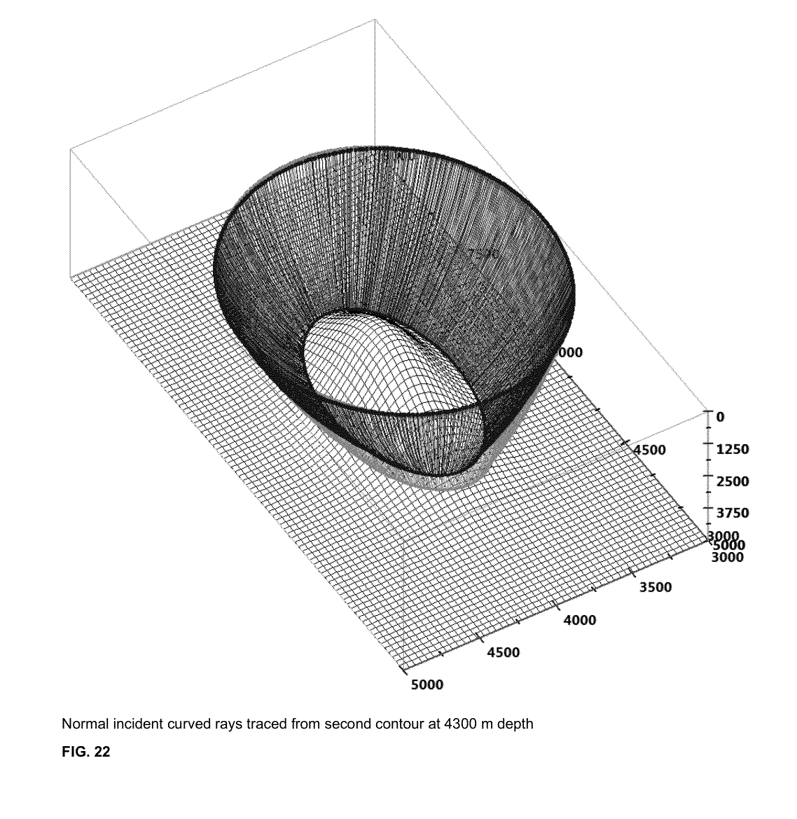

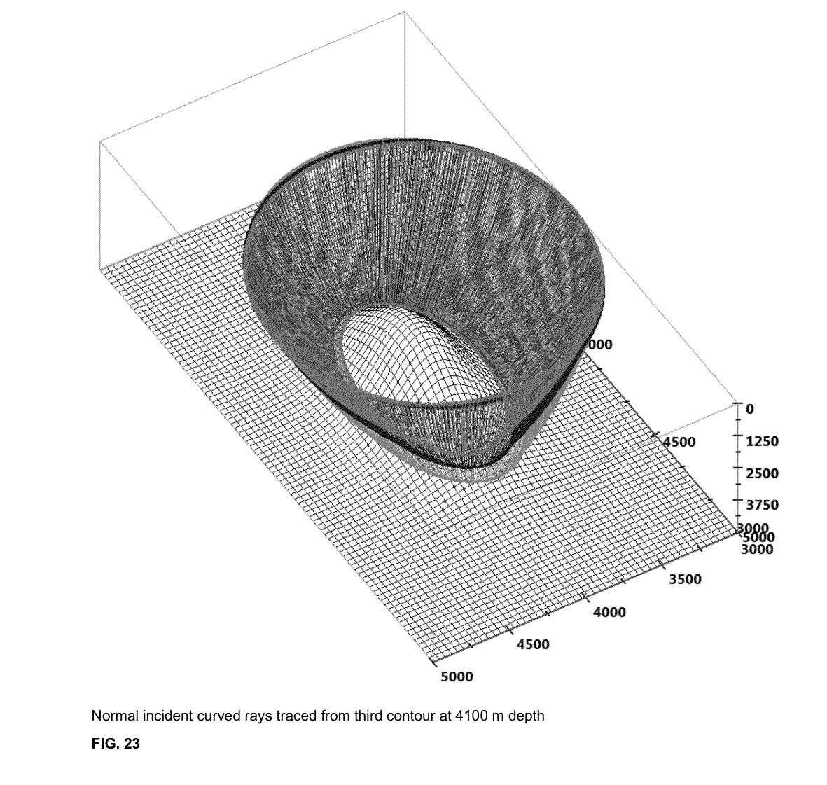

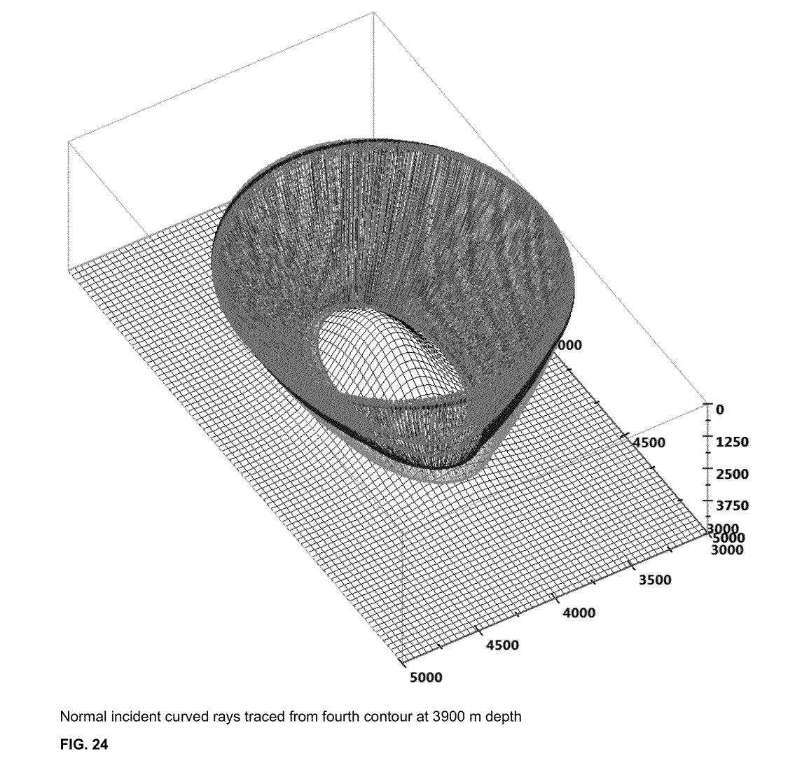

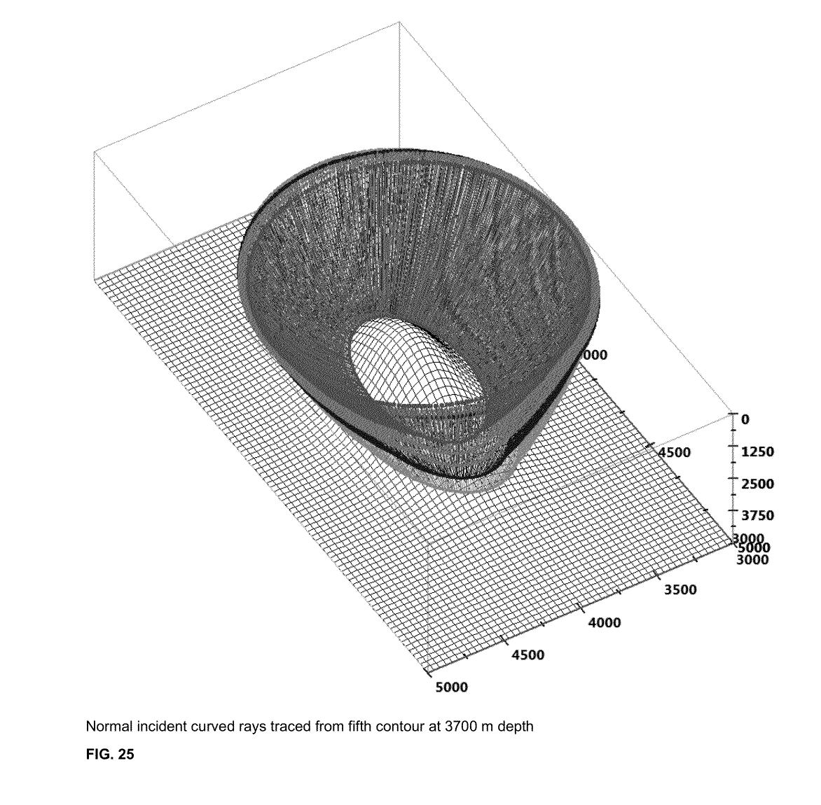

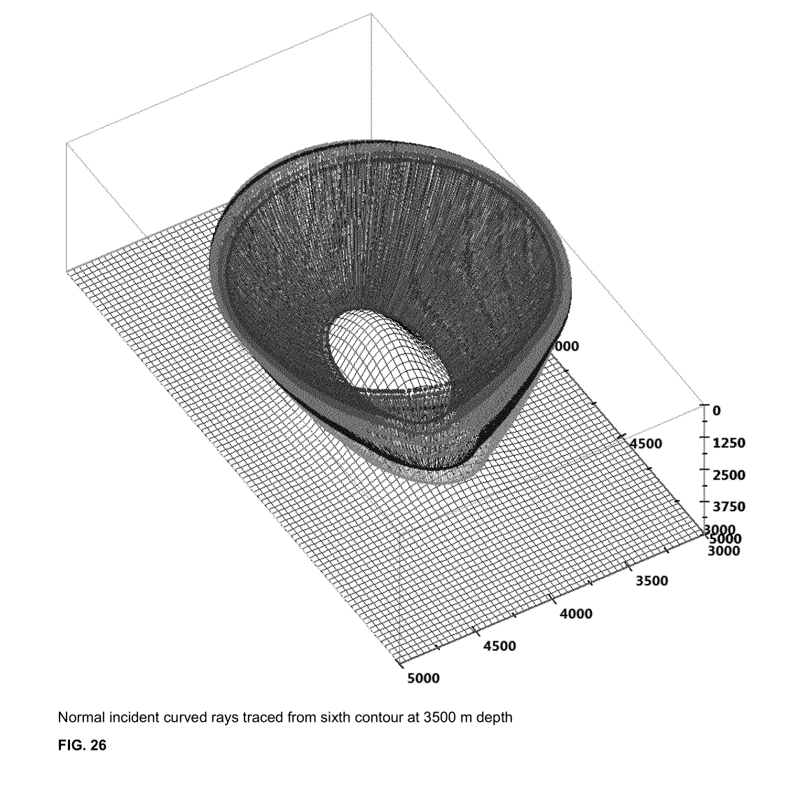

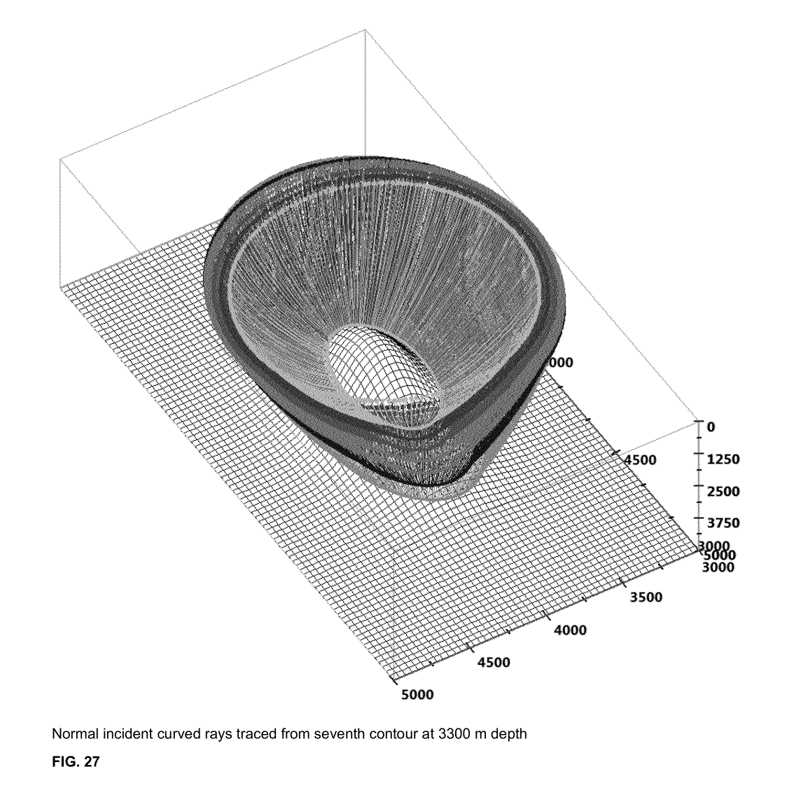

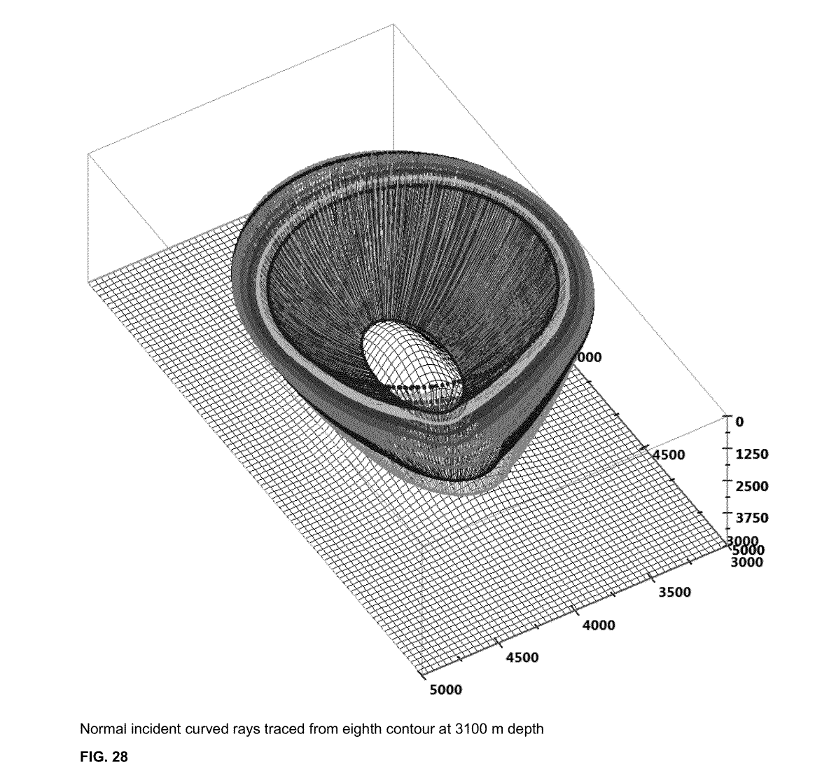

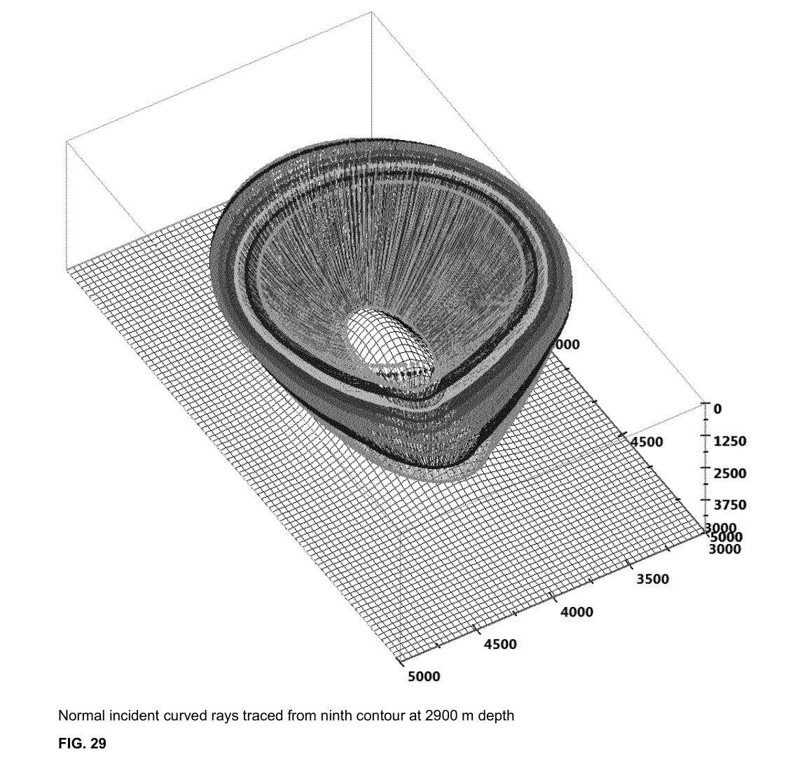

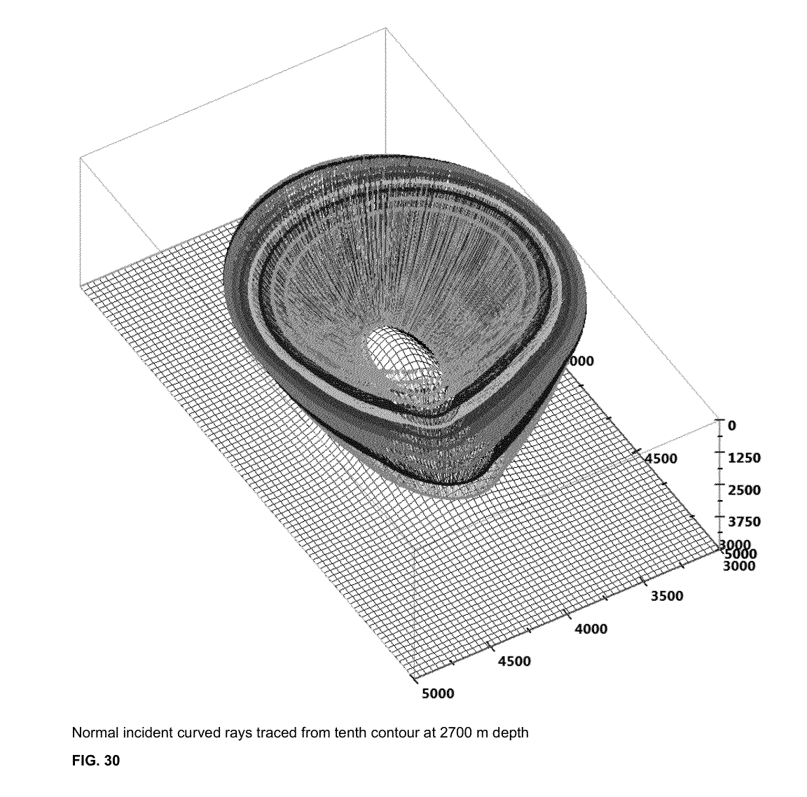

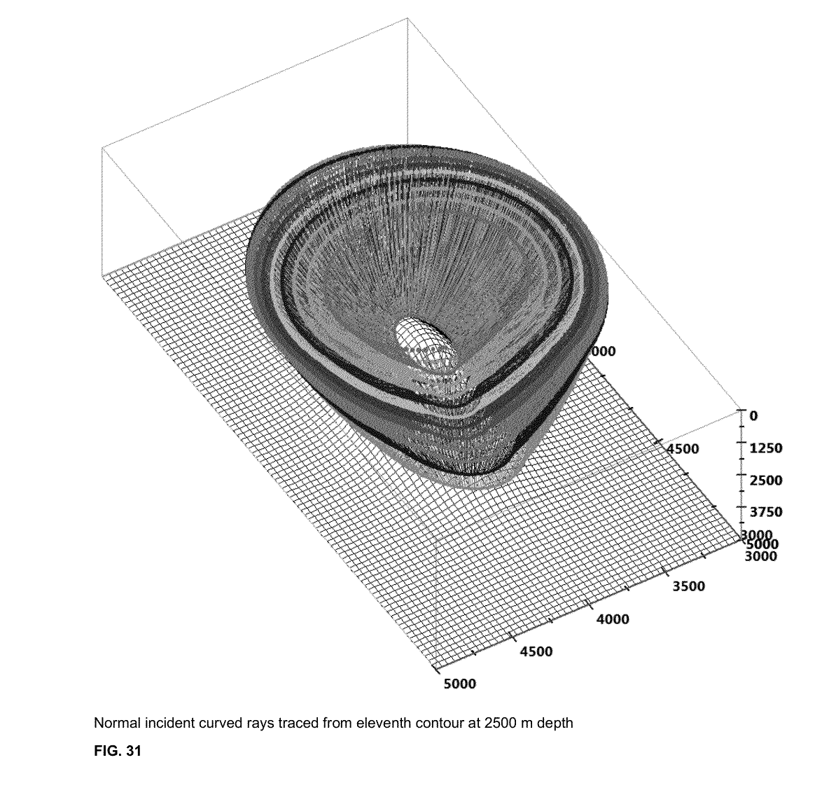

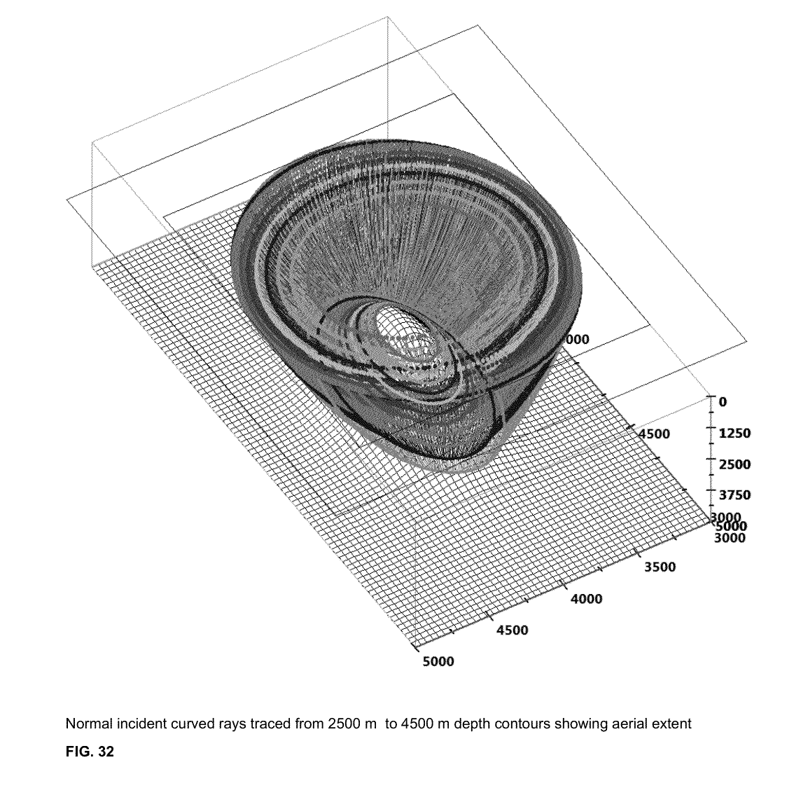

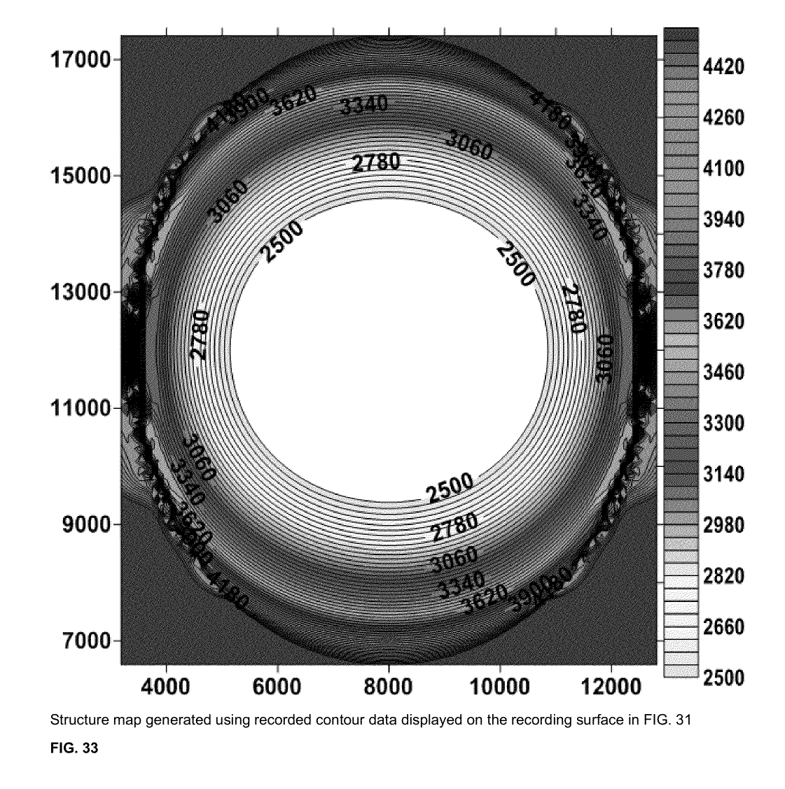

Normal incident curve ray is traced from each point on the structure contour to the recording surface. This ray tracing produces imaged contour points on the recording surface as shown in figure number (FIG. 20). The endpoints of the rays outline a contour on the recording surface, and it is called the imaged contour as shown in figure number (FIG. 20). This imaged contour corresponds to the contour on the structure display in figure number (FIG. 20). Similar rays are traced from each structure contour to the corresponding imaged contours as shown in figure number (FIG. 31). The coordinates x, y, z of imaged contours are calculated, and output to a computer storage device. The imaged contours are also called unmigrated contours of corresponding structure contours. The coordinates x, y, z of structure contours are calculated, and output to a computer storage device. The structure contours are also called migrated contours.

The stored x, y, z coordinates of imaged contours are imported from a computer storage device into a commercially available gridding and mapping software. The mapping software transforms the input data into a grid of data. The mapping software uses the gridded data to generate and display a structure map on a computer screen. This is a quality control map shown in figure number (FIG. 32). The stored x, y, z coordinates of structure contours are imported from a computer storage device into a commercially available gridding and mapping software. The mapping software transforms the input data into a grid of data. The mapping software uses the gridded data to generate and display a structure map on a computer screen. This is a quality control map shown in figure number (FIG. 33). Structure cross-sections are calculated along radial profiles from 0° to 180° at an increment. The cross-sections produce the coordinates of depth (x, y, z), 3-D dip (x, y, θ°), absolute 3-D dip (x, y, |θ°|), dip (x, y, θ°), and absolute 3-D dip (x, y, |θ°|) are calculated along profiles. These coordinates are output to a computer storage device.

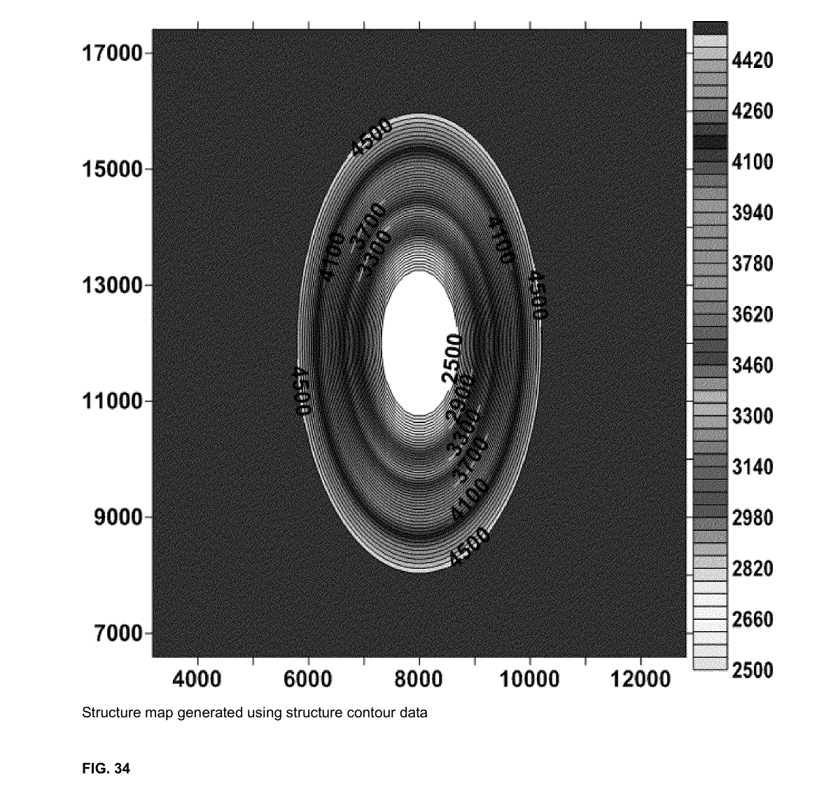

The stored x, y, z depth coordinates from cross-sections are imported from a computer storage device into a commercially available gridding and mapping software. The mapping software transforms the input data into a grid of data. The mapping software uses the gridded data to generate and display a structure map on a computer screen. This is a quality control structure map shown in figure number (FIG. 34). This structure map compares well with the structure map from structure contour data in figure number (FIG. 33).

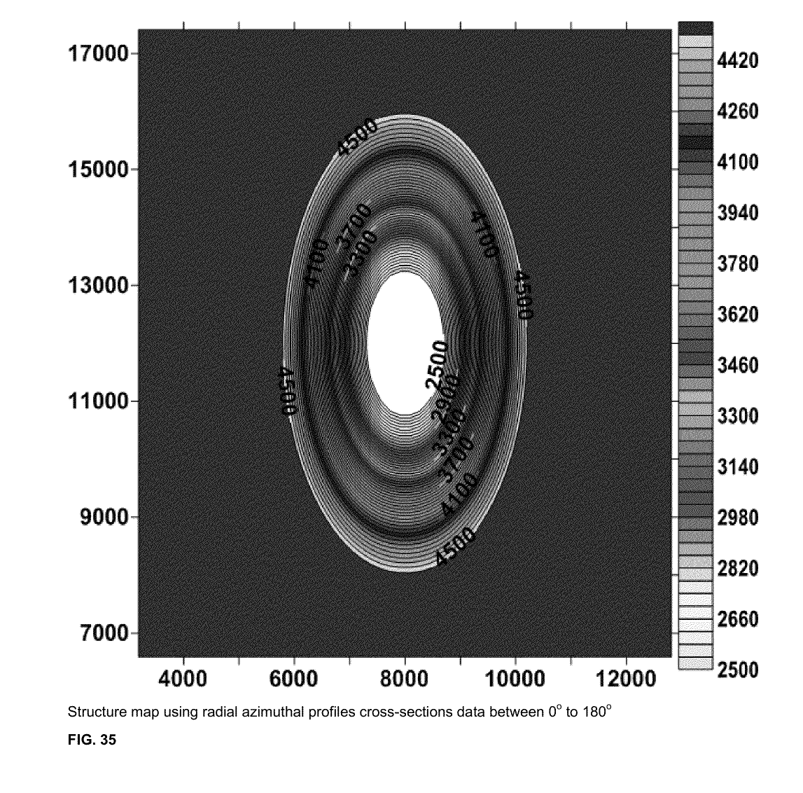

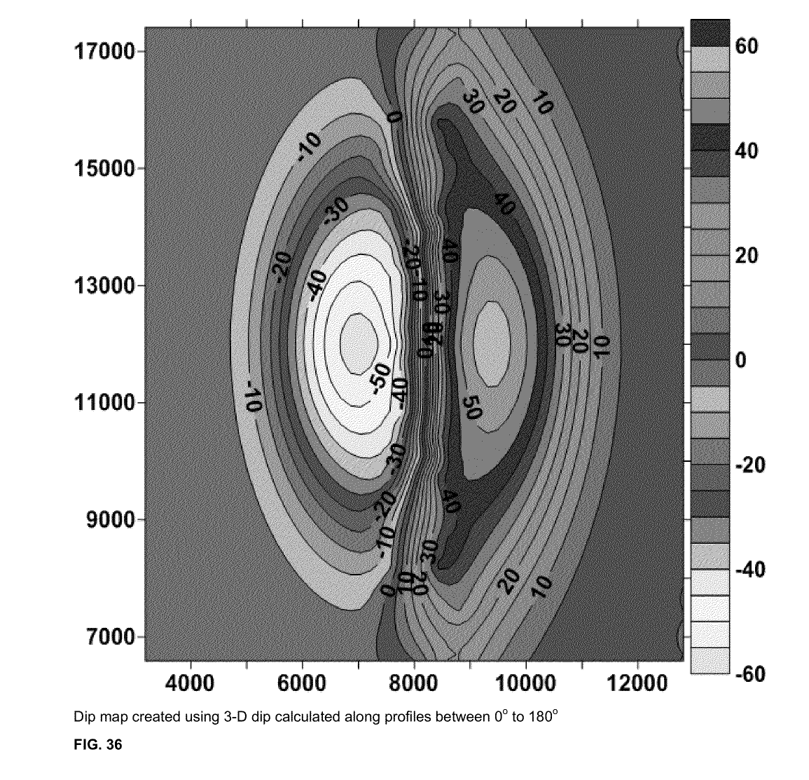

The stored 3-D dip (x, y, θ°) coordinates from cross-sections are imported from a computer storage device into a commercially available gridding and mapping software. The mapping software transforms the input data into a grid of data. The mapping software uses the gridded data to generate and display a 3-D dip map on a computer screen. This is a quality control 3-D dip map shown in figure number (FIG. 35). The 3-D dip map corresponds well with the structure map from structure contour data in figure number (FIG. 33). The stored dip (x, y, θ°) coordinates from cross-sections are imported from a computer storage device into a commercially available gridding and mapping software. The mapping software transforms the input data into a grid of data. The mapping software uses the gridded data to generate and display a dip map on a computer screen. This is a quality control dip map shown in figure number (FIG. 36). The dip map corresponds well with the structure map from structure contour data in figure number (FIG. 33).

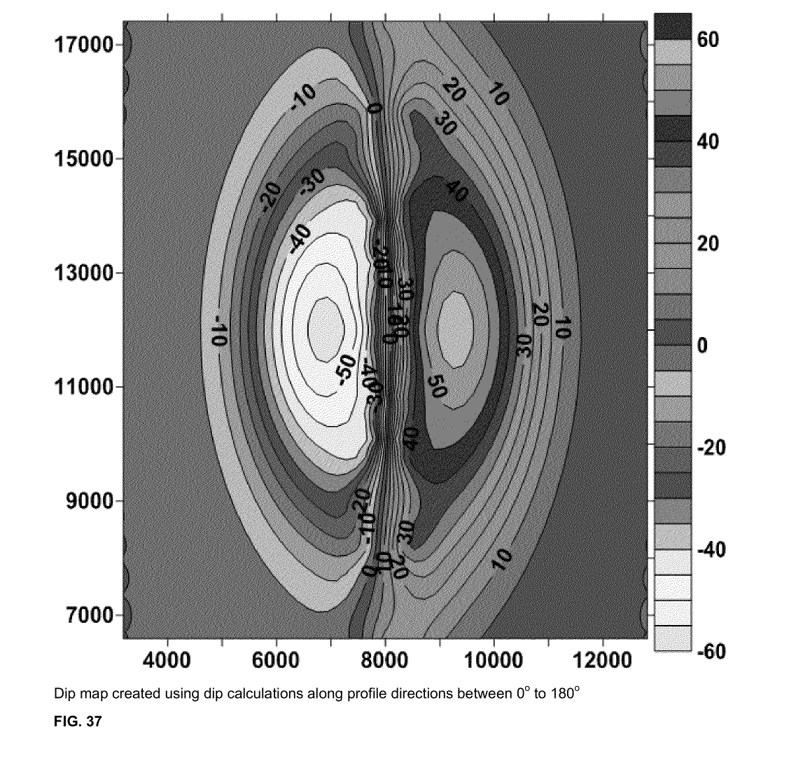

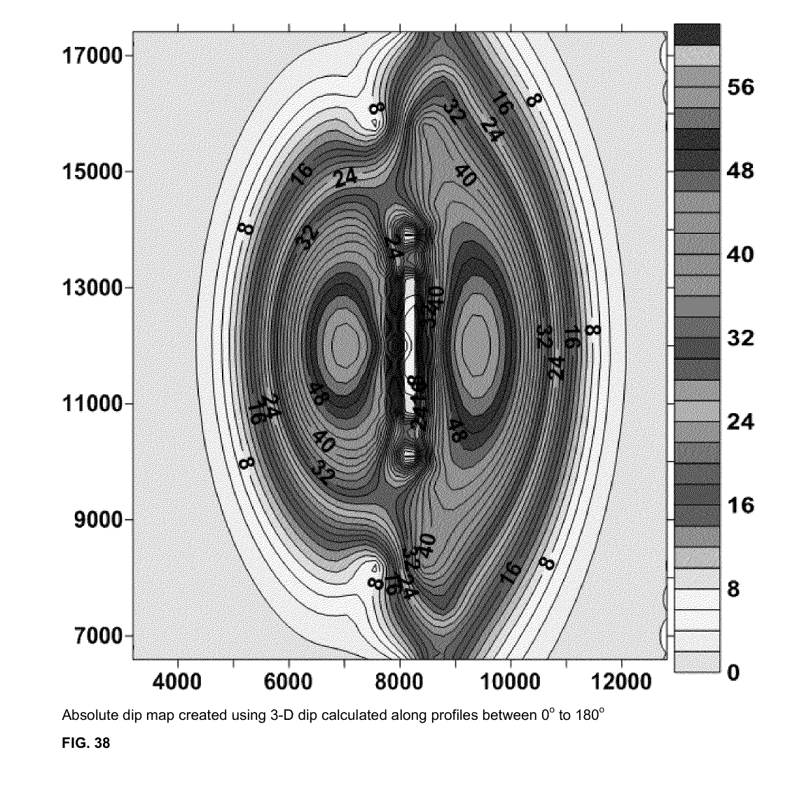

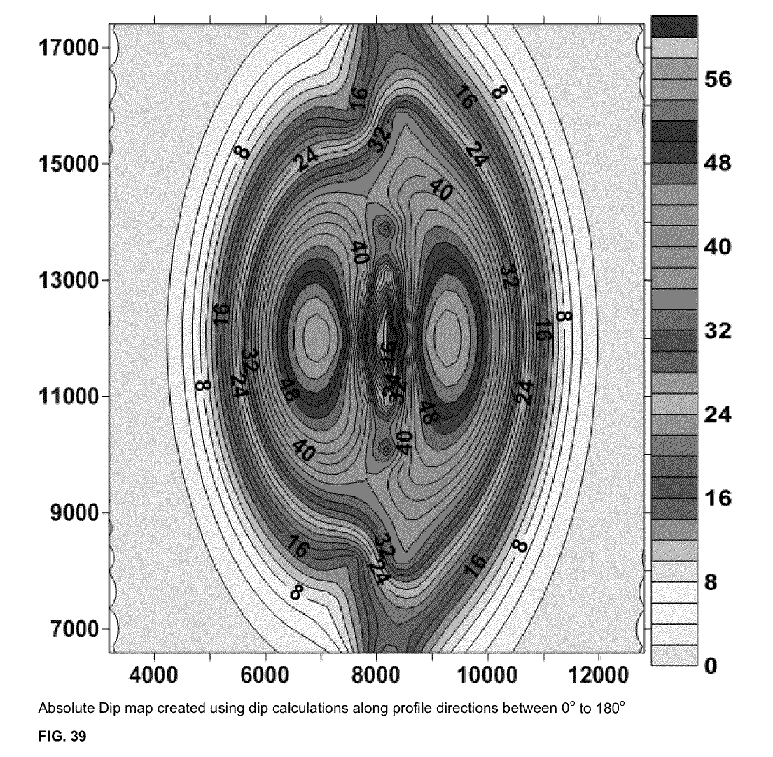

The stored absolute 3-D dip (x, y, |θ°|) coordinates from cross-sections are imported from a computer storage device into a commercially available gridding and mapping software. The mapping software transforms the input data into a grid of data. The mapping software uses the gridded data to generate and display an absolute 3-D dip map on a computer screen. This is a quality control absolute 3-D dip map shown in figure number (FIG. 37). The absolute 3-D dip map corresponds well with the structure map from structure contour data in figure number (FIG. 33). The stored absolute dip (x, y, |θ°|) coordinates from cross-sections are imported from a computer storage device into a commercially available gridding and mapping software. The mapping software transforms the input data into a grid of data. The mapping software uses the gridded data to generate and display an absolute dip map on a computer screen. This is a quality control absolute dip map shown in figure number (FIG. 38). The absolute dip map corresponds well with the structure map from structure contour data in figure number (FIG. 33).

The above quality control maps provide checks on the quality and consistency of the structure generated, either from parameters, or from borehole data. Quality control is based on cross-sections calculated along profiles from 0° to 180°. The cross-sections are calculated at an incrementto obtain finely sampled analyses for the given structure.

The following steps show how to obtain x, y, z coordinates of the imaged contours using 3-D seismic data: First, Process 3-D seismic volume without migration. Now use the unmigrated volume to create a 3-D stack volume of seismic data. Second, Interpret the 3-D seismic data over the desired structure. Third, generate a contour map of the interpreted structure. The contours on this map are unmigrated contours. Fourth, store x, y, z coordinates of the contours are output to a computer storage device. These stored coordinates represent unmigrated contour data. It is common practice to use 3-D Migration technique in all 3-D processing of seismic data. Therefore, a special reprocessing flow, omitting migration of 3-D seismic data, is necessary to achieve the above goal.

The following steps show how to obtain x, y, z coordinates of the structure using 3-D seismic data: First, Process 3-D seismic volume with the use of migration to create a 3-D stack volume of seismic data. Second, Interpret 3-D seismic data over the desired structure. Third, generate a contour map of the interpreted structure. The contours on this map are migrated contours. Fourth, output x, y, z coordinates of the contours are output to a computer storage device. These stored coordinates represent migrated contour data.

### Benefits of This Invention

Areal extent can be calculated by using prior art of 3-D seismic modeling. A step by step comparison is carried out to determine the advantages of one over the other. The step by step comparison between this method and the prior art of 3-D seismic modeling is shown in Table I.

The areal extent parameter for a geologic structure may be determined with commercially available 3-D seismic modeling software. It is necessary to carry out the following steps to determine areal extent using 3-D seismic modeling: (a) Obtain a 3-D modeling software. (b) Select a structure for modeling, and generate a 3-D model input of an interpreted geologic horizon. (c) Calculate petrophysical rock properties from well logs recorded over the structure. (d) Design the surface template for location of in-lines and cross-lines. (e) Generate zero offset 3-D volume to simulate un-migrated 3-D volume. (f) Create horizontal slices, interpret and outline the unmigrated structure contours, and generate a structure map. (g) Determine the areal extent from contours of structure maps. (h) Generate vertical incidence 3-D volume to simulate migrated 3-D volume. (i) Generate horizontal slices to interpret and outline the migrated structure contours to show the correct structural location.

The procedure of using this method to determine the areal extent is as follows: (a) Specify Structure parameters of length, width, shallowest and deepest depths, or import existing structure depth data. (b) Specify contours, contour interval, and ray interval. (c) Select the option for linear or curved ray tracing. (c) Rays are traced from all selected contours to the recording surface, and areal extent is determined from the imaged contours. (d) Generate quality control maps for unmigrated and migrated contours, cross-section depths and dips.

It would require extensive research and development for adapting an existing of 3-D seismic modeling program for determining the areal extent. 3-D seismic modeling must include the algorithm described here to achieve the steps defined in this method. A comparison of obtaining areal extent, using prior art of 3-D seismic modeling, and this method is given in Table I.

Table I shows the benefits of this invention as compared to using prior art to determine areal extent.

| Comparison | | | Geological Structure Contour Modeling and |
|---|---|---|---|
| Factor | Prior 3-D Seismic Modeling Technique | | Imaging |
| Software | 3-D modeling software | | This invention |
| Application | | | |
| Cost | Expensive (Several Hundred Thousand | | Relatively Inexpensive (Less than $5,000) |
| | Dollars) | | |
| Time | Slow (a few days to weeks or more) | | Fast (a few minutes) |
| Collection of | Requires an extensive geological and | | Generates a 3-D structure with a few |
| data for | geophysical procedures to prepare a | | parameters or pre-existing structure depth |
| required input | complete 3-D model input data (days to | | data are used (few minutes). |
| | weeks). | | |
| Preparation of | 3-D model input is usually a structure map | | 3-D model input is generated based on the |
| input data for 3- | created in seismic interpretation. (few hours | | available parameters or pre-existing structure |
| D surface | to days). | | map (a few seconds). |
| Petrophysical | Velocity of P & S, and density of all of the | | Single P-wave velocity gradient with depth |
| parameters | layers in 3-D model. | | only rock property required. |
| Determine | (a) | Generate zero offset 3-D volume to | Generates imaged contours on the recording |
| areal extent | | simulate un-migrated 3-D volume. | surface by tracing linear/curved normal |
| | | (minutes to hours). | incident rays from each structure contour to |
| | (b) | Generate horizontal slices to outline the | its corresponding location on the recording |
| | | structure. (minutes to hours). | surface. Areal extent is calculated and |
| | (c) | Determine the areal extent from structure | displayed for normal/oblique incidence angle |
| | | contours of the structure. (minutes). | (a few seconds). |
| Imaged | Does not show imaged contours and | | Shows the imaged contours, and displays |
| contours | crossing contours. | | crossing contours if they exist. |
| Display | Rays are scattered over structural surface, | | Rays appear orderly from structure contours |
| contours and | therefore, the visual display of all rays is | | to the recording surface. The rays and the |
| Rays | chaotic and difficult to visualize. | | contours are seen clearly. |
| Quality control | a) | Unmigrated structure map from horizontal | Generates quality control maps for |
| maps for | | slices using normal incident rays. (minutes | unmigrated and migrated contours, cross- |
| structure | | to hours). | section depths and dips (few minutes). |
| | b) | Migrated structure map from horizontal | |
| | | slices using vertical incident rays. | |
| | | (minutes to hours). | |

| | | |
|---|---|---|
| Dip Maps | Not commonly available during survey | Four Dip maps are generated for quality |
| | design, can be generated from interpreted | control (few seconds). |
| | horizon map (minutes to hours). | |

Parametric Definition of a Structure in 3-D

Define the 3-D structure by a smooth and continuous function z=z₀+z₁*ƒ(x,y), e.g., a Gaussian function as:

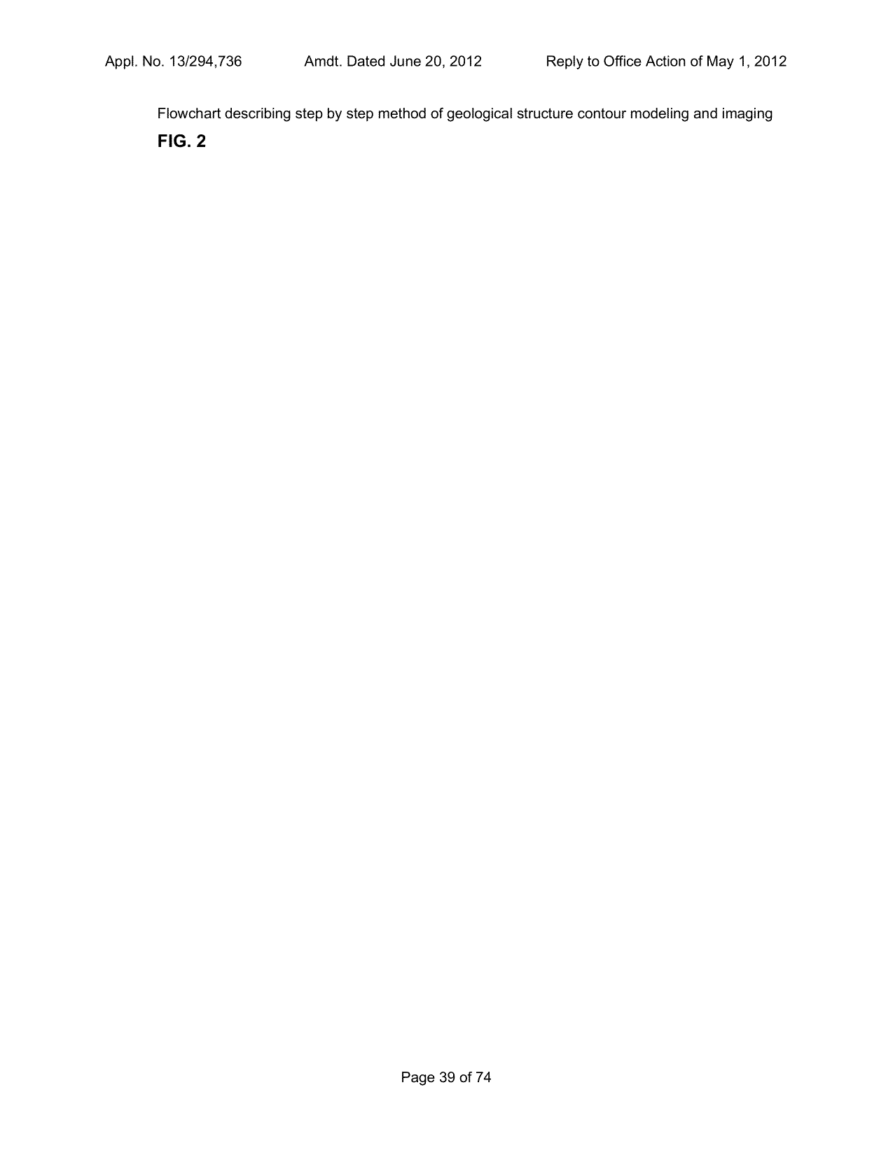

z=z₀+z₁*e^{(-ax-by)} (1)

Where, z is the calculated depth, z₀ and z₁ are depth related constants to establish the depth and height of the structure. Constants a and b determine the width of the structure in x and y dimensions respectively. The above constants are required for calculating the 3-D coordinates of a structure. A grid, of x, y, z coordinates, is calculated. The calculated coordinates are scaled to screen coordinates, and displayed as a wire mesh diagram shown in figure number (FIG. 2).

A specified contour at depth z=z_{c}, is calculated by substituting the specified depth value for z in equation (1), for each x, y, coordinate along this contour. These calculations are repeated for each specified contour.

The next step is to trace a normal incident ray starting from a point on a selected contour to the recording surface. Linear raypath normal incidence from structure to the recording surface is achieved by using the following linear equations:

x₀=xₙ+dx*zₙ (2)

y₀=yₙ+dy*zₙ (3)

z₀=0 (4)

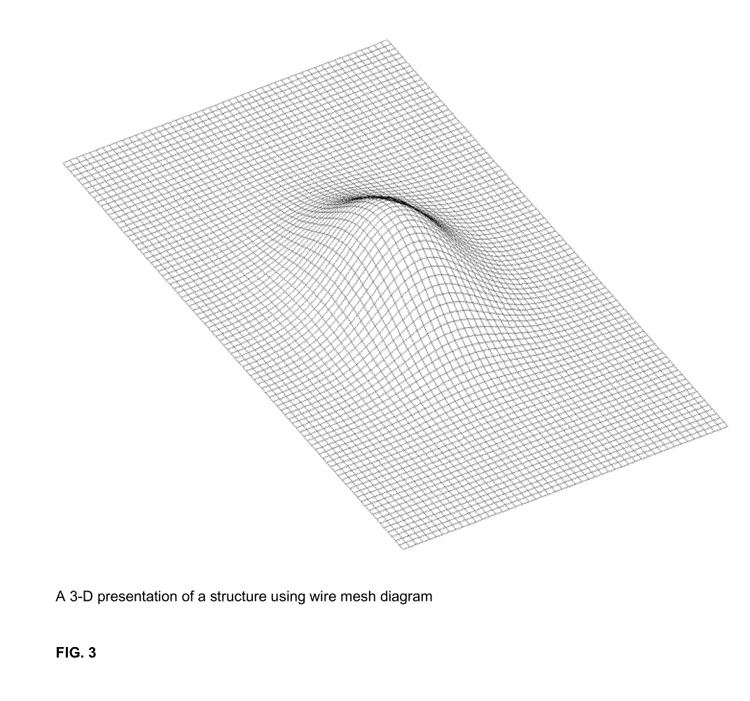

The parameters in equations (2), (3), and (4), are shown in figure number (FIG. 3), and are defined here. The coordinates (xₙ, yₙ, zₙ) represent point B on the structure contour. The coordinates (x₀, y₀, z₀) represent the point A on the recording surface, where the ray BA terminates. The partial derivatives dx and dy are calculated at point B. The coordinates (xₙ, yₙ, zₙ), and (x₀, y₀, z₀) are output to a computer storage device.

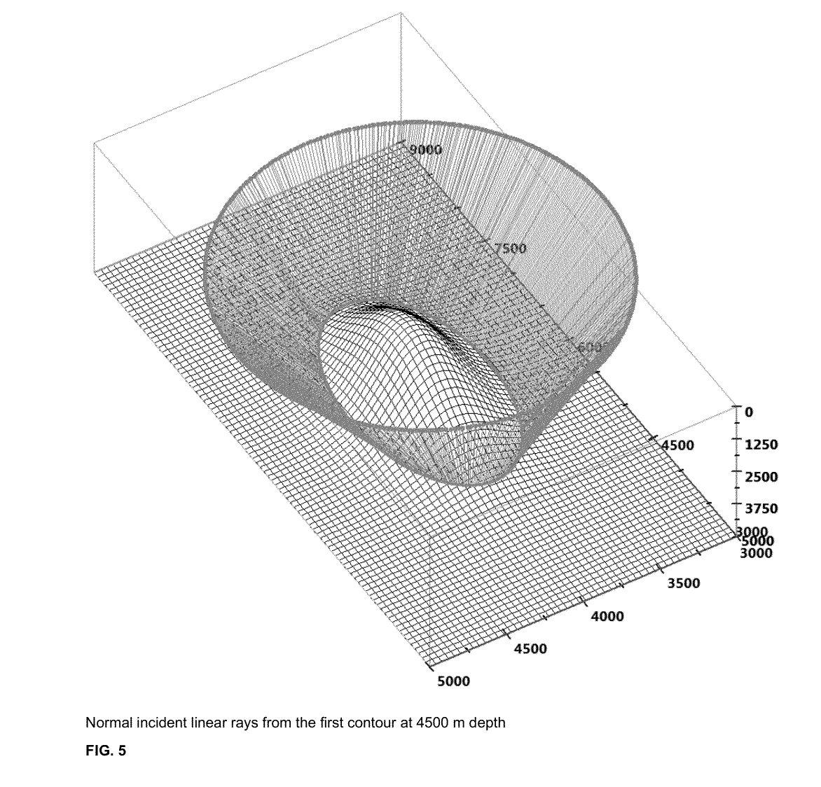

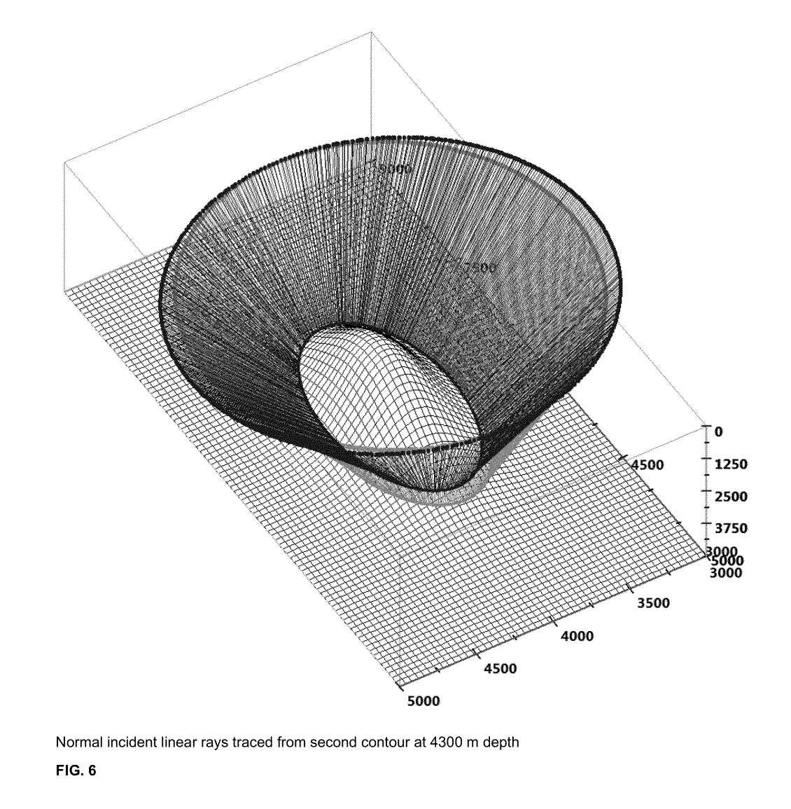

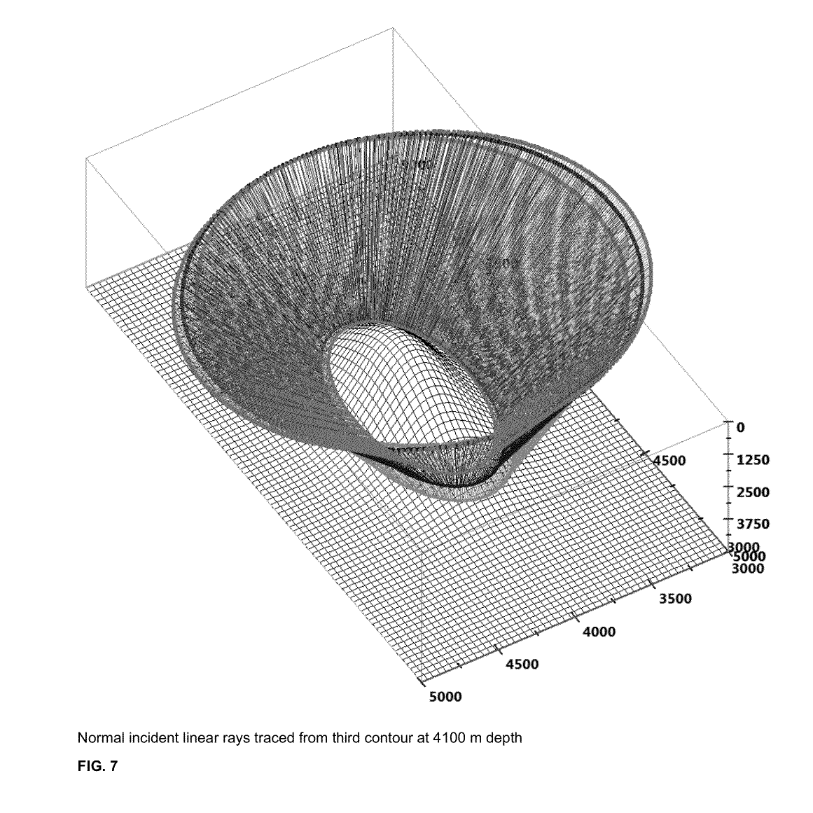

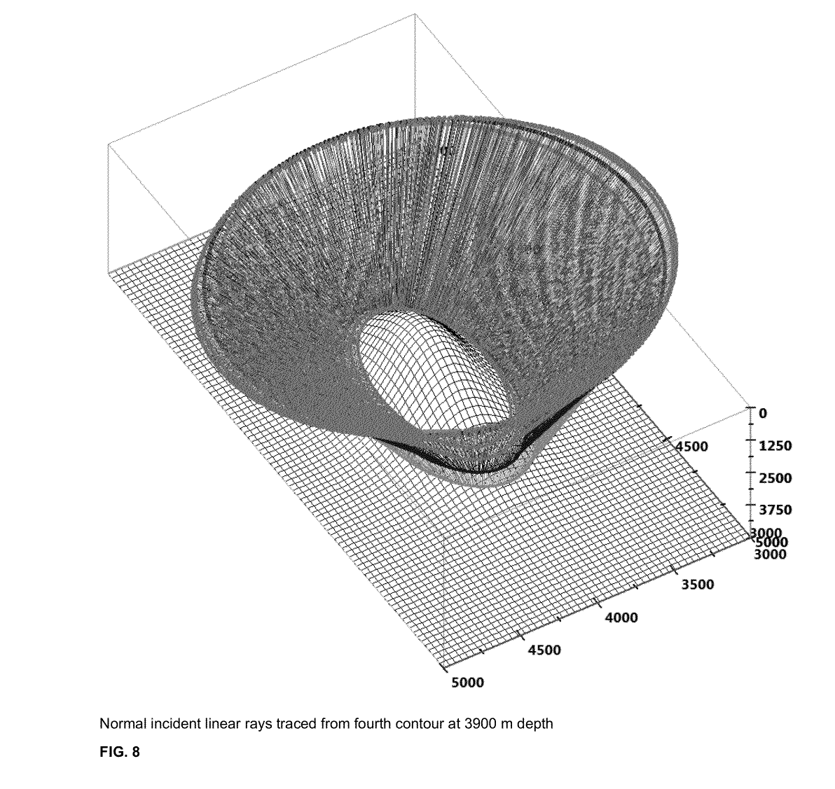

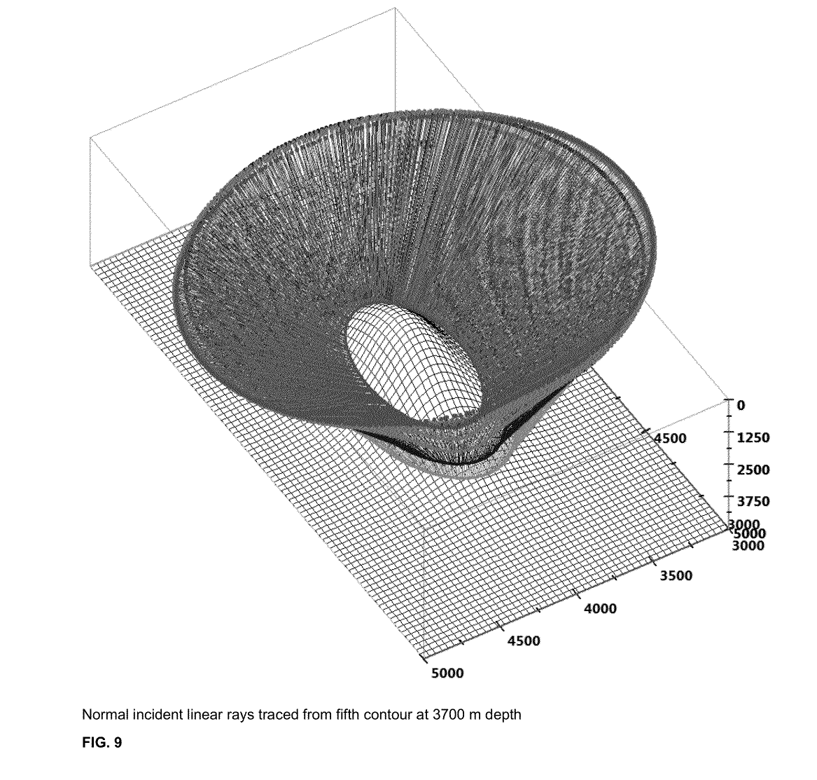

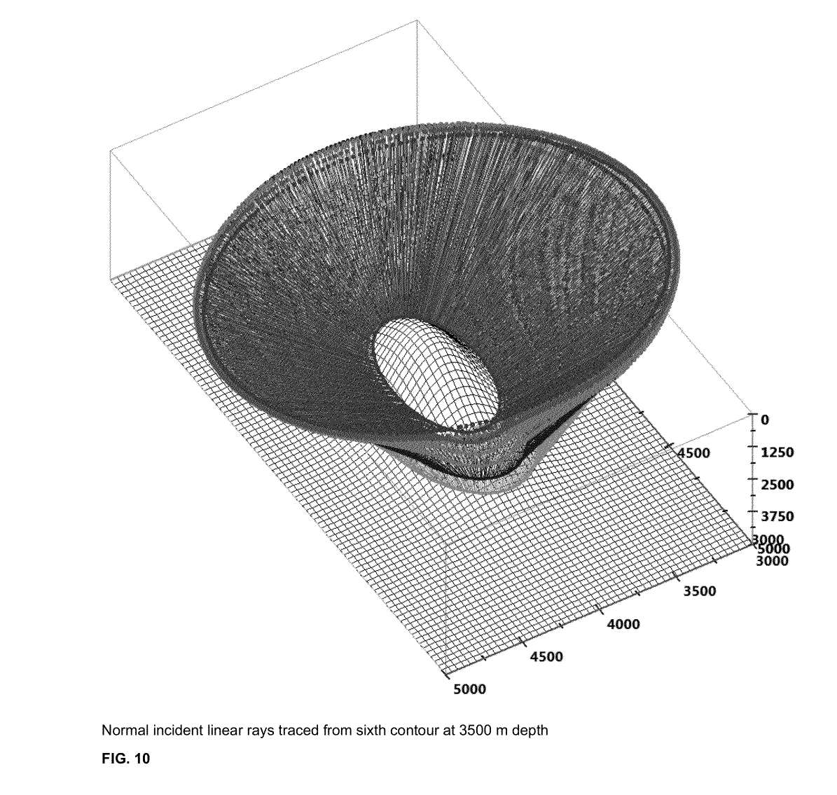

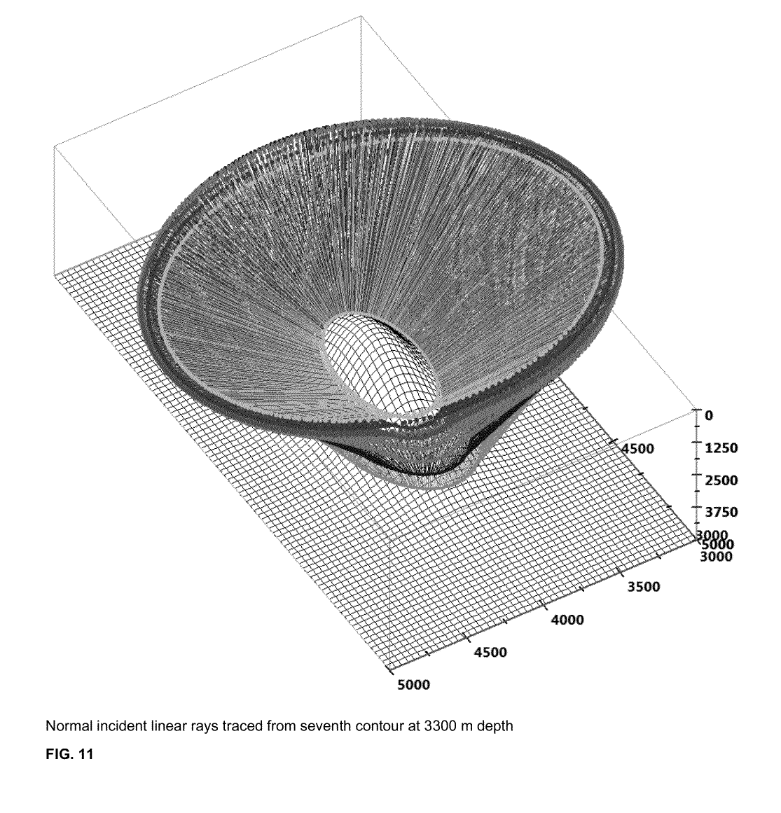

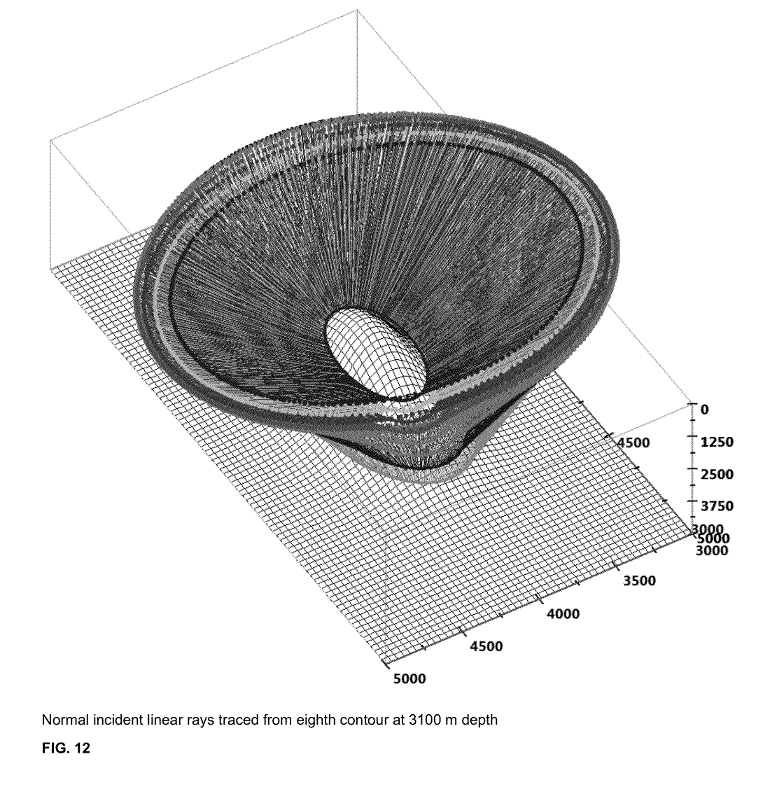

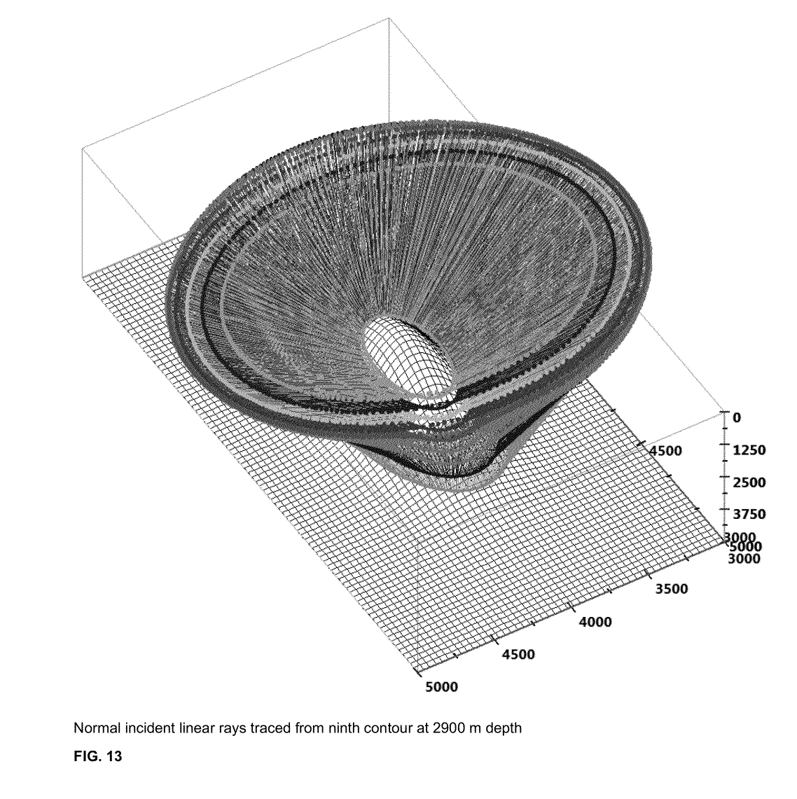

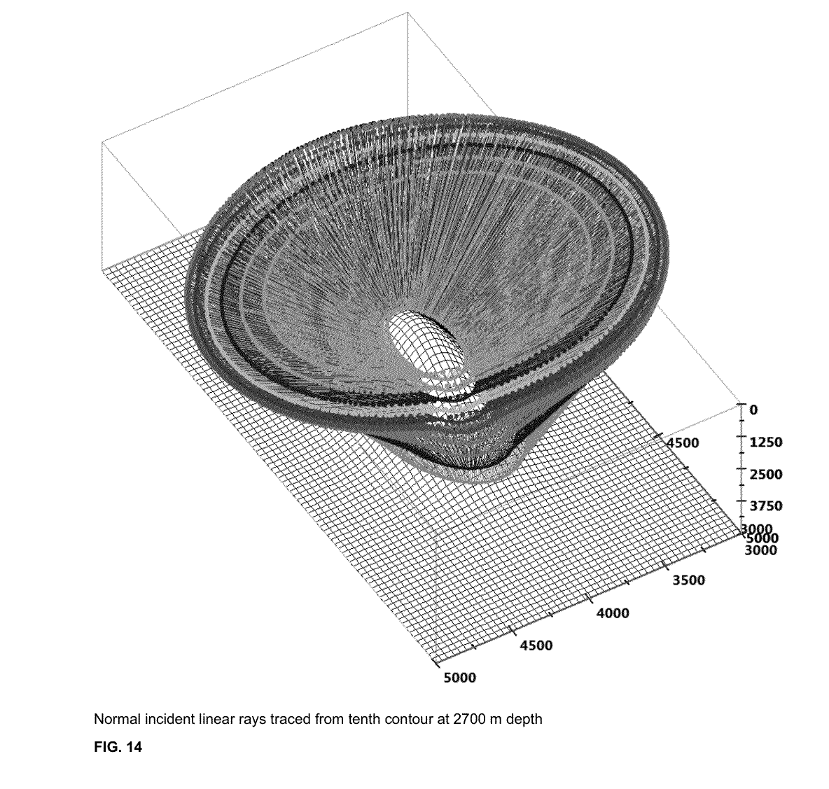

The slope of the structure at point B in figure number (FIG. 3) is calculated. A normal to this slope is calculated to the recording surface. This step is accomplished using equations 2, 3, and 4, to locate point A as in figure number (FIG. 3). Next step is to mark the starting point on the structure contour plot. A normal incident ray, starting from the structure contour, is plotted to its termination point at the recording surface. Normal incident linear rays are traced from all points along the specified structure contour to the recording surface. Last step is to highlight, the points outlining the structure contour, and points outlining the imaged contours on the recording surface as shown in figure number (FIG. 4). The above procedure is repeated for all selected structure contours as shown in figure numbers (FIG. 5 to FIG. 14). The whole process may be repeated for additional structures.

Main Steps for Plotting Normal Incident Linear Rays are as follows:
(a) A structure contour at a selected depth is defined and calculated for the geologic structure as shown in figure number (FIG. 3).
(b) Normal incident linear rays are traced and plotted from points along the contour to the recording surface.
(c) Additional rays are traced to increase the resolution, and plotted from points between traced rays.
(d) Resolution is enhanced by tracing and plotting rays at a finer spacing as shown in figure number (FIG. 4).
(e) The process of ray tracing and plotting is completed for all structure contours as shown in figure numbers (FIG. 5 to FIG. 14).

Imaged contours on the recording surface, and structure contours are highlighted as in figure number (FIG. 15). An inside rectangle representing the areal extent of the imaged contours is drawn as in figure number (FIG. 15). An outside rectangle, to include the effect of the maximum source-receiver offset distance is drawn as in figure number (FIG. 15). Normal incident rays imply source-receiver separation distance is zero. Source-receiver distance varies from a few meters to a few thousand meters during seismic data acquisition. The outside rectangle is calculated by expanding the inside rectangle around its center by one maximum offset distance in x, y directions. The outside rectangle accounts for the maximum source-receiver distance for a given seismic survey.

Method of Curved Raypath With Linear Increase in Velocity With Depth

A linear increase in velocity with depth may be expressed as:

V=V₀+k*Z (5)

Where, k=constant for linear increment of velocity with depth, V₀=initial velocity at the surface, Z=depth variable

For 90° incident angle,

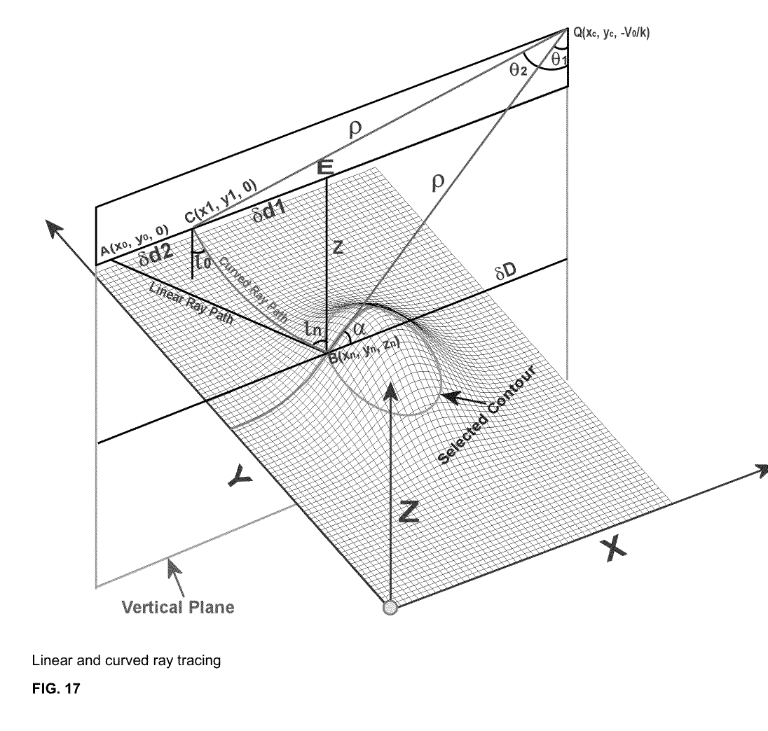

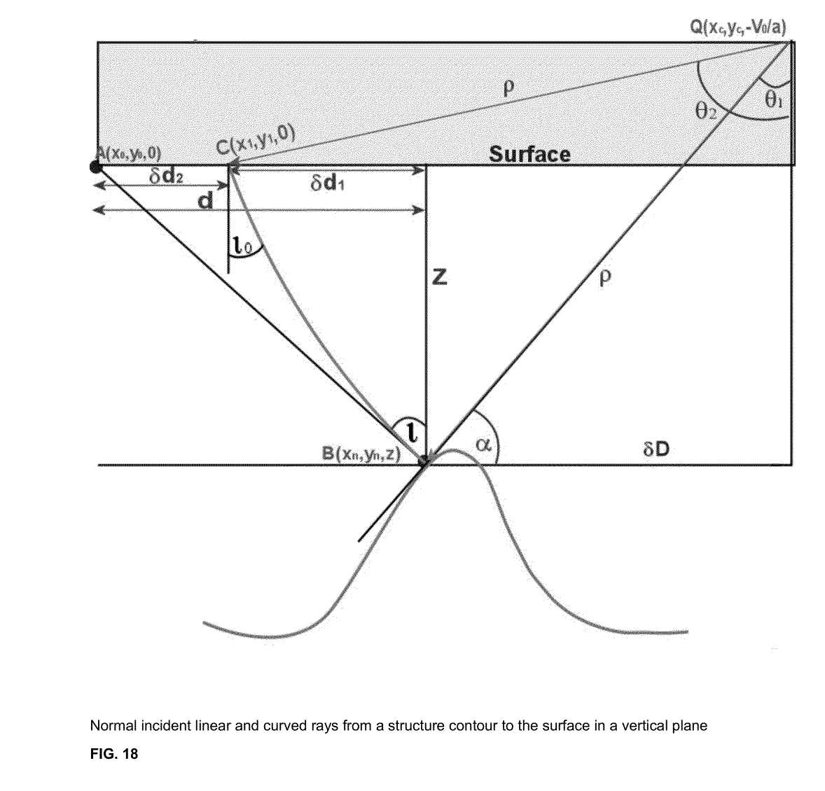

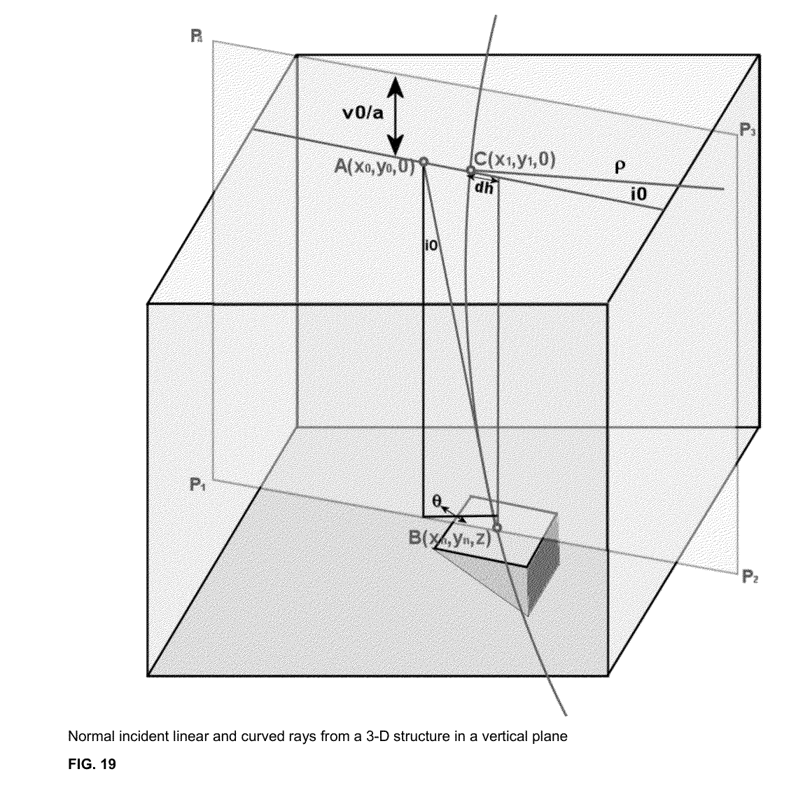

iₙ=90°−θ₁=90°−90°+α=α (6)

Where, α=is the slope of structural surface at the point of reflection B, as shown in figure numbers (FIG. 16, FIG. 17, and FIG. 18)

For normal incidence, the dip of the structure at the reflection point is equal to the incidence angle, as shown in figure numbers (FIG. 16, FIG. 17, and FIG. 18), therefore,

iₙ=α (7)

Using standard definition of curved ray parameter P, as given in geophysical references including wave propagation in multi-layered media, e.g., Sheriff et al, 1999 and Telford et al, 1978, and substituting velocity gradient from equation (5) for velocity Vₙ=V₀+k*Z as:

$$\begin{matrix}P = \frac{sin {i}_{0}}{{V}_{0}} \\ = \frac{sin {i}_{n}}{{V}_{n}} \\ = \frac{sin {i}_{n}}{{V}_{0} + k * z}\end{matrix} \qquad ( 23 )$$

Where i₀=is the initial ray angle at the starting point C on the surface as in figure number (FIG. 16).

Substituting for iₙ from equation (7) into equation (8), we obtain:

$$P = \frac{Sin α}{{V}_{0} + k * z} \qquad ( 9 )$$

The initial curved ray angle at the starting point C on the surface is calculated from equation (8) as:

i₀=Sin⁻¹(PV₀) (10)

ρ is the radius (Sheriff et al, 1999, Telford et al, 1978) of the circle defined by radius QB or QC with center at Q (x_{c}, y_{c},

$$- \frac{{V}_{0}}{k} ) .$$

as shown in figure numbers (FIG. 16 and FIG. 17) and given by:

$$\begin{matrix}ρ = \frac{1}{Pk} \\ = \frac{{V}_{0}}{k Sin {i}_{0}}\end{matrix} \qquad ( 11 )$$

The offset distance CE=δd₁, as shown in figure numbers (FIG. 16 and FIG. 17), for the curved ray path is calculated by knowing iₙ, P, i₀, from equations (7), (8), and (10):

$$δ {d}_{1} = \frac{1}{Pk} ( Cos {i}_{0} - Cos {i}_{n} ) \qquad ( 12 )$$

The offset distance AE=d, as shown in figure numbers (FIG. 16 and FIG. 17), for the linear ray path is calculated as:

d=Z Tan(α) (13)

The difference between the linear and curved ray offsets δd₂, as shown in figure numbers (FIG. 16 and FIG. 17), can now be calculated from equations (12) and (13):

δd₂=d−δd₁ (14)

Let us define a ratio r₁ from equation (13) and (14) as:

$${r}_{1} = \frac{δ {d}_{2}}{d} \qquad ( 15 )$$

Using the ratio r₁ derive the surface coordinates of the curved ray at location C as follows:

x₁=xₙ+r₁(xₙ−x₀) (16)

y₁=yₙ+r₁(yₙ−y₀) (17)

The depth at any point along the curved ray path can be calculated using the following formula (Sheriff et al, 1999, Telford et al, 1978),

$$Z = \frac{1}{Pk} ( Sin i - Sin {i}_{0} ) \qquad ( 18 )$$

Finally, calculate the angles θ₁, θ₂, and the coordinates of point Q which is the center for the circular arc with radius ρ as follows:

From equation (6), we obtain:

θ₁=90°−α (19)

From the figure numbers (FIGS. 16, 17, and 18) we get

$$Cos {θ}_{2} = \frac{{V}_{0}}{k ρ} \qquad ( 20 )$$

From equation (20),

$${θ}_{2} = {Cos}^{- 1} ( \frac{{V}_{0}}{k ρ} ) \qquad ( 21 )$$

Also, radius ρ is now obtained from equation (20) as

$$ρ = \frac{{V}_{0}}{k Cos {θ}_{2}} \qquad ( 22 )$$

From figure numbers (FIG. 16 and FIG. 17), We can express:

δD=ρ Sin θ₁ (23)

Define the ratio,

$${r}_{2} = \frac{δ D}{d} \qquad ( 24 )$$

Now, calculate the coordinates (x_{c}, y_{c}) at location Q

x_{c}=xₙ+r₂(xₙ−x₀) (25)

y_{c}=yₙ+r₂(yₙ−y₀) (26)

Here are two different methods of calculating and displaying curved ray path:
(a) Plot a circular arc with Q(x_{c}, y_{c},

$$- \frac{{V}_{0}}{k} )$$

coordinates as the center (Sheriff et al, 1999, Telford et al, 1978), and ρ as the radius between points C(x₁, y₁, 0) and B(xₙ,yₙ,zₙ)
(b) Calculate points along the curved ray starting at the surface point C(x₁,y₁,0) and down to the point B(xₙ,yₙ,zₙ) on the structure. These calculations of (x, y, z) coordinates are carried out using equations (16), (17), and (18). The coordinates (xₙ, yₙ, zₙ), and (x₁, y₁, 0) are output to a computer storage device.

Normal incident linear/curved rays are traced and plotted from each point along the selected contour. A finer interval ray tracing provided higher resolution imaging, and vice versa. Rays are calculated, scaled, and plotted from successive contours. The plotting continues until rays are traced and plotted from all specified contours.

Main Steps for Plotting Normal Incident Curved Rays are as follows:
(a) A structure contour at a selected depth is defined and calculated for the geologic structure as shown in figure number (FIG. 16).
(b) Normal incident curved rays are calculated, scaled, and plotted from points along the contour to the recording surface.
(c) Additional rays are traced to increase the resolution, and plotted from points between previously traced rays.
(d) Resolution is enhanced by tracing and plotting rays at a finer spacing as shown in figure number (FIG. 20).
(e) The process of ray tracing and plotting is completed for all structure contours as shown in figure number (FIG. 20) to figure number (FIG. 31).

Imaged contours on the recording surface, and structure contours are highlighted as in figure number (FIG. 31). An inside rectangle, representing the areal extent of the imaged contours is drawn as in figure number (FIG. 31). An outside rectangle, to include the effect of the maximum source-receiver offset distance is drawn as in figure number (FIG. 31). For normal incident rays, the source-receiver offset distance is zero. Source-receiver distance varies from a few meters to a few thousand meters during seismic data acquisition. The outside rectangle is calculated by expanding the inside rectangle around its center by one maximum offset distance in x, y directions. The outside rectangle accounts for the maximum source-receiver distance for a given seismic survey.

Following are the steps for generating x, y, z coordinates for structure and imaged contours. This method generates and stores x, y, z coordinates of imaged and structure contours in a computer storage device. The imaged contours are formed by the endpoints of the linear/curved ray paths terminating at the recording surface. The x, y, z coordinates of these endpoints are the coordinates of the imaged contours and are output to a computer storage device. Structure contour coordinates are the x, y, z coordinates of the starting points of the linear/curved ray on the structure. These x, y, z coordinates are output to a computer storage device.

The stored x, y, z coordinates of imaged contours at the recording surface are imported from a computer storage device into a commercially available gridding and mapping software. The mapping software transforms the scattered input data into a grid of equally spaced columns and rows. The mapping software uses the gridded data to generate and display a structure map on a computer screen. This map is equivalent to a structure map generated by interpretation of unmigrated seismic data. The effect of the crossing contours can be seen on this structure map. Further, this map shows apparent and artificial features, commonly called artifacts. These artifacts are generated by the combination of crossing contours on the recording surface. The automated gridding, and mapping algorithms display these artifacts as in figure number (FIG. 32). These artificial features can be misinterpreted as real lithologic features. One must recognize the crossing contour effect in structure maps. Such features may be found on structure maps created by interpreting and mapping unmigrated seismic data.

The stored x, y, z coordinates of structure contours are imported from a computer storage device into a commercially available gridding and mapping software. The mapping software transforms the scattered input data into a grid of equally spaced columns and rows. The mapping software uses the gridded data to generate and display a structure map on a computer screen. This map is equivalent to a structure map generated by interpretation of migrated seismic data. This contour map compares well with the original structure map. The structure map from interpretation of migrated seismic data shows the structure at its correct location in figure number (FIG. 33). Moreover, there are no crossing contours on this map of structure contours. The imaged contour represents the contours generated by interpretation of unmigrated data. Structure contours represent contours generated by the interpretation of migrated data.

Steps for generating x, y, z coordinates of cross-sections along radial profiles are outlined here. The x, y, z coordinates are extracted from cross-sections of the structure along radial profiles. The radial profiles range in azimuths from 0° to 180° at a small interval of 1°. The extracted x, y, z coordinates of cross-sections are output to a computer storage device. The stored x, y, z coordinates are input to commercially available gridding and mapping software. This mapping software grids the input data, generates and displays a structure map on a computer screen. This map provides a quality control to determine if the structure contours and their location correctly represent the structure as in figure number (FIG. 34).

Steps for generating x, y, 3-D dip, coordinates of cross-sections along radial profiles are outlined here. 3-D dip is the dip calculated in 3-D along the direction of cross-section profile. The x, y, 3-D dip, coordinates are extracted from cross-sections of the structure along radial profiles. The radial profiles range in azimuths from 0° to 180° at a small interval of 1°. The extracted x, y, 3-D dip, coordinates of cross-sections are output to a computer storage device. The stored x, y, 3-D dip, coordinates are input to commercially available gridding and mapping software. This mapping software grids the input data, generates and displays a 3-D dip map on a computer screen. This map provides a quality control to determine if the dip map is consistent with the structure map as in figure number (FIG. 35).

Steps for generating x, y, Dip, coordinates of cross-sections along radial profiles are outlined here. Dip is the dip calculated along the direction of cross-section profile. The x, y, Dip, coordinates are extracted from cross-sections of the structure along radial profiles. The radial profiles range in azimuths from 0° to 180° at a small interval of 1°. The extracted x, y, Dip, coordinates of cross-sections are output to a computer storage device. The stored x, y, Dip, coordinates are input to commercially available gridding and mapping software. This mapping software grids the input data, generates and displays a dip map on a computer screen. This map provides a quality control to determine if the dip map is consistent with the structure map as in figure number (FIG. 36).

Steps for generating x, y, |3-D dip|, coordinates of cross-sections along radial profiles are outlined here. The absolute 3-D dip is calculated in 3-D along the direction of cross-section profile. The x, y, |3-D dip|, coordinates are extracted from cross-sections of the structure along radial profiles. The radial profiles range in azimuths from 0° to 180° at a small interval of 1°. The extracted x, y, |3-D dip|, coordinates of cross-sections are output to a computer storage device. The stored x, y, |3-D dip|, coordinates are imported from specific columns of saved Excel Spreadsheet into a commercially available gridding and mapping software. This mapping software grids the input data, generates and displays a |3-D dip| map on a computer screen. This map provides a quality control to determine if the |3-D dip| map is consistent with the structure map as in figure number (FIG. 37).

Steps for generating x, y, |Dip|, coordinates of cross-sections along radial profiles are outlined here. |Dip| is the absolute dip calculated along the direction of cross-section profile. The x, y, coordinates are extracted from cross-sections of the structure along radial profiles. The radial profiles range in azimuths from 0° to 180° at a small interval of 1°. The extracted x, y, |Dip|, coordinates of cross-sections are output to a computer storage device. The stored x, y, |Dip|, coordinates are imported from specific columns of saved Excel Spreadsheet into a commercially available gridding and mapping software. This mapping software grids the input data, generates and displays a |Dip| map on a computer screen. This map provides a quality control to determine if the |Dip| map is consistent with the structure map as in figure number (FIG. 36).

1-11. (canceled)

12. A computerized and automated method comprising the steps of (a) producing a 3-D model of a geologic structure, (b) defining structure contours, (c) tracing linear/curved normal incident rays or circular arcs from the structure contours to imaged contours on a recording surface, (d) calculating an areal extent of the imaged contours on the recording surface, (e) outlining contours formed by the intersection of normal incident linear/curved rays with a recording surface, and (f) outlining calculated structure contours marking the reflecting point for each normal incident linear/curved ray on structural surface.

13. The method of claim 12 wherein said step (a) of producing the 3-D model of the geologic structure further includes the steps of (1) generating a parametric 3-D geological structural model based on structure width, length, height, and depth to a top of the geologic structure or based on structure depth data, and (2) generating a grid of x, y, z values for the geologic structure using small increments in x and y dimensions.

14. The method of claim 13 further including the step of storing the grid of x, y, z values for the geologic structure on a computer storage device.

15. The method of claim 13 further including the step of scaling coordinates (x, y, z) to computer screen coordinates and graphically plotting on a computer screen.

16. The method of claim 12 wherein said step (b) of defining the structure contours further includes the steps of (1) calculating coordinates (x, y, z) of finely spaced points along the structure contours, and (2) repeating the previous step until said structure contours are calculated.

17. The method of claim 16 further including the step of saving the said coordinates (x, y, z) of said contours to a computer storage device.

18. The method of claim 16 further including the step of scaling the x, y, z coordinates of said structure contours to screen coordinates and graphically plotting on a computer screen.

19. The method of claim 12 wherein the step (c) of tracing the normal incident rays further comprises the steps of (1) calculating linear rays from each starting point (x, y, z) along said structure contours to the endpoint (x, y, z) on the imaged contours, and (2) repeating the previous step for said structure contours.

20. The method of claim 19 further including the steps of (1) scaling said linear rays coordinates (x, y, z) of starting points and endpoints to screen coordinates, and (2) plotting scaled coordinates on a computer screen.

21. The method of claim 19 further including the step of storing said coordinates (x, y, z) of imaged contours on a computer storage device.

22. The method of claim 19 further including the steps of (1) scaling the coordinates (x, y, z) of imaged contours to screen coordinates, (2) plotting scaled coordinates on a computer screen, and (3) outlining contour coordinates on a computer screen.

23. The method of claim 12 wherein the step (c) of tracing said normal incident curved rays further includes the steps of (1) calculating points along the normal incident curved rays from said point (x, y, z) along the structure contours to the endpoint (x, y, z) on the imaged contours at the recording surface, (2) repeating the previous step for said structure contours, and (3) outlining contour coordinates on a computer screen.

24. The method of claim 23 further including the steps of (1) scaling said points along the curved rays coordinates (x, y, z) to screen coordinates, and (2) plotting scaled coordinates on a computer screen.

25. The method of claim 23 further including the step of storing said coordinates (x, y, z) of imaged contours on a computer storage device.

26. The method of claim 23 further including the steps of (1) scaling said coordinates (x, y, z) of imaged contours to screen coordinates, and (2) plotting on computer screen.

27. The method of claim 12, wherein the step (c) of tracing the circular arcs further includes the steps of (1) calculating the circular arcs from each starting point (x, y, z) along the said structure contours to the endpoint (x, y, z) on the imaged contours, and (2) saving coordinates (x, y, z) of the starting point on the structure and coordinates (x, y, z) of the endpoint to a computer storage device.

28. The method of claim 27 further including the steps of (1) scaling said coordinates (x, y, z) of the arcs representing curved rays to screen coordinates, and (2) plotting on a computer screen.

29. The method of claim 21 further including the steps of (1) importing the stored coordinates (x, y, z) of imaged contours from the computer storage device into a gridding and mapping software (2) gridding the input data, and (3) generating and displaying a structure map on a computer screen simulating contour map created by interpretation of unmigrated seismic data.

30. The method of claim 17 further including the steps of (1) importing the saved coordinates (x, y, z) of structure contours from the computer storage device into a gridding and mapping software (2) gridding the input data, and (3) generating and displaying a structure map on a computer screen simulating contour map created by the interpretation of migrated seismic data.

31. The method of claim 13 further including the steps of (1) calculating coordinates (x, y, z) of cross-sections along azimuthal radial profiles, (2) saving said coordinates (x, y, z) to a computer storage device, (3) importing coordinates (x, y, z) from the computer storage device into a gridding and mapping software (4) gridding the input data, and (5) generating and displaying a structure map for quality control of 3-D structure shape and position.

32. The method of claim 13 further including the step of calculating coordinates and 3-D dip values of cross-sections along azimuthal profiles, and further including the step of saving coordinates of (x, y, 3-D dip), (x, y, |3-D dip|), (x, y, dip), and (x, y, |dip|) to a computer storage device.

33. The method of claim 32 further including the steps of (1) importing said saved coordinates of: (x, y, 3-D dip), (x, y, |3-D dip|), (x, y, dip), and (x, y, |dip|) from the computer storage device into a gridding and mapping software, (2) gridding the input data, and (3) generating and displaying a dip map for each set of said coordinates to quality control the dip and shape of the structure.

34. The method of claim 22, wherein the step (d) of calculating the areal extent of the imaged contours on the recording surface further includes the steps of: (1) calculating the dimensions of a rectangle representing the areal extent parameter which encloses the imaged contours on the recording surface, (2) scaling the rectangle to screen coordinates and plotting on a computer screen, (3) calculating a larger rectangle to account for maximum offset used in seismic surveys, (4) scaling to screen coordinates, and (5) plotting on a computer screen.

35. The method of claim 26, wherein the step (d) of calculating the areal extent of the imaged contours on the recording surface further includes the steps of: (1) calculating the dimensions of a rectangle representing the areal extent parameter which encloses the imaged contours on the recording surface, (2) scaling the rectangle to screen coordinates and plotting on a computer screen, (3) calculating a larger rectangle to account for maximum offset used in seismic surveys, (4) scaling to screen coordinates, and (5) plotting on a computer screen.
